(19) United States
(12) Patent Application Publication
(10) Pub. No.: US 2023/0316062 A1
(43) Pub. Date: Oct. 5, 2023

(54) LAYER-BY-LAYER TRAINING FOR FEDERATED LEARNING

(71) Applicant: QUALCOMM Incorporated, San Diego, CA (US)

(72) Inventors: Eren Balevi, San Diego, CA (US); Taesang Yoo, San Diego, CA (US); Tao Luo, San Diego, CA (US); Srinivas Yerramalli, San Diego, CA (US); Junyl Li, Fairless Hills, PA (US); Hamed Pezeshki, San Diego, CA (US)

(21) Appl. No.: 17/697,751

(22) Filed: Mar. 17, 2022

(51) Int. Cl. H04B 7/06; G06N 3/04; G06N 3/08

(52) U.S. Cl. CPC G06N 3/08; G06N 3/04; H04B 7/0626

(57) ABSTRACT

Methods, systems, and devices for wireless communications are described. A network entity may transmit an indication of neural network weights to one or more user equipments (UEs). The neural network weights may be for one or more shared layers of a federated learning neural network. The UEs may train a personalized layer of the neural network using the weights and data at the UEs. The UEs may transmit layer updates to the network entity. The network entity may train the neural network based on the updates. The UEs may send a transmission to the network entity that may be processed according to the neural network at the UEs and the network entity.

### FIELD OF TECHNOLOGY

The following relates to wireless communications, including layer-by-layer training for federated learning.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities or one or more network access nodes, each simultaneously supporting communication for multiple communication devices, which may be otherwise known as user equipment (UE).

### SUMMARY

The described techniques relate to improved methods, systems, devices, and apparatuses that support layer-by-layer training for federated learning. Generally, the described techniques provide for one or more user equipment (UE) to train one or more hierarchical layers of a neural network according at different cadences or training frequencies. For example, a network entity, such as a base station or core network (CN) entity, may transmit neural network weights for shared layers of the neural network to surrounding UEs. A UE may train a layer, or multiple layers, of the neural network using the weights and a set of training data according to a schedule and frequency of training that are specific to that layer. The layers trained by the UE may be referred to as personalized layers of the neural network. The UE may perform a transmission to the network entity by applying the personalized layers, which may include shared layers, one or more layers private to the UE, or a combination thereof. The network entity may train the neural network using the weights and one or more reported UE updates to layers. The network entity may process the transmission using the trained neural network.

A method for wireless communication at a UE is described. The method may include receiving, from a network entity, a first set of neural network weights corresponding to a first subset of a set of multiple hierarchical layers of a neural network, where the set of multiple hierarchical layers of the neural network are aggregated at different network entities and associated with different training frequencies in federated training, training, according to a first training frequency, a first layer of the set of multiple hierarchical layers based on the first set of neural network weights and a set of training data at the UE, where the first layer is outside of the first subset of the set of multiple hierarchical layers, and performing a transmission to the network entity, where the transmission is processed at the UE through the set of multiple hierarchical layers of the neural network in accordance with the training.

An apparatus for wireless communication at a UE is described. The apparatus may include a processor, memory coupled with the processor, and instructions stored in the memory. The instructions may be executable by the processor to cause the apparatus to receive, from a network entity, a first set of neural network weights corresponding to a first subset of a set of multiple hierarchical layers of a neural network, where the set of multiple hierarchical layers of the neural network are aggregated at different network entities and associated with different training frequencies in federated training, training, accord to a first training frequency, a first layer of the set of multiple hierarchical layers based on the first set of neural network weights and a set of training data at the UE, where the first layer is outside of the first subset of the set of multiple hierarchical layers, and perform a transmission to the network entity, where the transmission is processed at the UE through the set of multiple hierarchical layers of the neural network in accordance with the training.

Another apparatus for wireless communication at a UE is described. The apparatus may include means for receiving, from a network entity, a first set of neural network weights corresponding to a first subset of a set of multiple hierarchical layers of a neural network, where the set of multiple hierarchical layers of the neural network are aggregated at different network entities and associated with different training frequencies in federated training, means for training, according to a first training frequency, a first layer of the set of multiple hierarchical layers based on the first set of neural network weights and a set of training data at the UE, where the first layer is outside of the first subset of the set of multiple hierarchical layers, and means for performing a transmission to the network entity, where the transmission is processed at the UE through the set of multiple hierarchical layers of the neural network in accordance with the training.

A non-transitory computer-readable medium storing code for wireless communication at a UE is described. The code may include instructions executable by a processor to receive, from a network entity, a first set of neural network weights corresponding to a first subset of a set of multiple hierarchical layers of a neural network, where the set of multiple hierarchical layers of the neural network are aggregated at different network entities and associated with different training frequencies in federated training, training, accord to a first training frequency, a first layer of the set of multiple hierarchical layers based on the first set of neural network weights and a set of training data at the UE, where the first layer is outside of the first subset of the set of multiple hierarchical layers, and perform a transmission to the network entity, where the transmission is processed at the UE through the set of multiple hierarchical layers of the neural network in accordance with the training.

Some examples of the method, apparatuses, and non-transitory computer-readable medium described herein may further include operations, features, means, or instructions for transmitting, to the network entity, at least a portion of the set of training data at the UE.

In some examples of the method, apparatuses, and non-transitory computer-readable medium described herein, the portion of the set of training data includes channel state information (CSI) feedback.

Some examples of the method, apparatuses, and non-transitory computer-readable medium described herein may further include operations, features, means, or instructions for training a second layer of the set of multiple hierarchical layers based on training the first layer and the set of training data at the UE, where the first set of neural network weights corresponds to the second layer and transmitting, to the network entity, a second set of neural network weights for the second layer based on training the second layer.

Some examples of the method, apparatuses, and non-transitory computer-readable medium described herein may further include operations, features, means, or instructions for combining the first set of neural network weights corresponding to a second layer of the set of multiple hierarchical layers and a second set of neural network weights produced from training the first layer to obtain a combined set of neural network weights, training the set of multiple hierarchical layers of the neural network based on the combined set of neural network weights and the set of training data at the UE, the training producing a third set of neural network weights, and performing the transmission to the network entity including the third set of neural network weights based on training the set of multiple hierarchical layers.

Some examples of the method, apparatuses, and non-transitory computer-readable medium described herein may further include operations, features, means, or instructions for applying, at a first time, a second layer of the set of multiple hierarchical layers to a set of data, where the first set of neural network weights corresponds to the second layer and applying, at a second time after the first time, the first layer to the set of data to obtain the transmission.

Some examples of the method, apparatuses, and non-transitory computer-readable medium described herein may further include operations, features, means, or instructions for combining the first set of neural network weights corresponding to a second layer of the set of multiple hierarchical layers and a second set of neural network weights produced from training the first layer to obtain a combined set of neural network weights, applying, at a first time, a second layer of the set of multiple hierarchical layers to a set of data, where the second layer may be trained according to the combined set of neural network weights, and applying, at a second time after the first time, the first layer to the set of data to obtain the transmission.

In some examples of the method, apparatuses, and non-transitory computer-readable medium described herein, training, according to a second training frequency, one or more copies of the first layer of the set of multiple hierarchical layers based on the first set of neural network weights and an additional set of training data at the UE.

Some examples of the method, apparatuses, and non-transitory computer-readable medium described herein may further include operations, features, means, or instructions for determining the UE may be part of a group of UEs within a radio unit (RU).

In some examples of the method, apparatuses, and non-transitory computer-readable medium described herein, the RU may be part of a group of RUs within a distributed unit (DU), and a second layer of the set of multiple hierarchical layers may be trained by the RU based on the set of training data at the UE, a set of training data at the RU, or both.

In some examples of the method, apparatuses, and non-transitory computer-readable medium described herein, the DU may be part of a group of DUs within a centralized unit (CU), and a third layer of the set of multiple hierarchical layers may be trained by the DU based on the set of training data at the UE, the set of training data at the RU, a set of training data at the DU, or any combination thereof.

In some examples of the method, apparatuses, and non-transitory computer-readable medium described herein, the CU may be part of a group of CUs within a CN, and a fourth layer of the set of multiple hierarchical layers may be trained by the CU based on the set of training data at the UE, the set of training data at the RU, the set of training data at the DU, a set of training data at the CU, or any combination thereof.

Some examples of the method, apparatuses, and non-transitory computer-readable medium described herein may further include operations, features, means, or instructions for processing the transmission using an auto-encoder, where the hierarchical layers may be trained at the auto-encoder based on the set of training data at the UE, a set of training data at the network entity, or both.

In some examples of the method, apparatuses, and non-transitory computer-readable medium described herein, the first layer may be an outermost layer of the set of multiple hierarchical layers trained at the auto-encoder, an innermost layer of the set of multiple hierarchical layers trained at the auto-encoder, or both.

A method for wireless communication at a network entity is described. The method may include transmitting, to one or more UE, a first set of neural network weights corresponding to a first subset of a set of multiple hierarchical layers of a neural network, where the set of multiple hierarchical layers of the neural network are aggregated at different network entities and associated with different training frequencies in federated training, training, according to a first frequency, a first layer of the set of multiple hierarchical layers based on the first set of neural network weights and one or more UE updates to the set of multiple hierarchical layers of the neural network, and receiving, from the one or more UE, a transmission and process the transmission through the set of multiple hierarchical layers of the neural network in accordance with the training.

An apparatus for wireless communication at a network entity is described. The apparatus may include a processor, memory coupled with the processor, and instructions stored in the memory. The instructions may be executable by the processor to cause the apparatus to transmit, to one or more UE, a first set of neural network weights corresponding to a first subset of a set of multiple hierarchical layers of a neural network, where the set of multiple hierarchical layers of the neural network are aggregated at different network entities and associated with different training frequencies in federated training, training, accord to a first frequency, a first layer of the set of multiple hierarchical layers based on the first set of neural network weights and one or more UE updates to the set of multiple hierarchical layers of the neural network, and receive, from the one or more UE, a transmission and process the transmission through the set of multiple hierarchical layers of the neural network in accordance with the training.

Another apparatus for wireless communication at a network entity is described. The apparatus may include means for transmitting, to one or more UE, a first set of neural network weights corresponding to a first subset of a set of multiple hierarchical layers of a neural network, where the set of multiple hierarchical layers of the neural network are aggregated at different network entities and associated with different training frequencies in federated training, means for training, according to a first frequency, a first layer of the set of multiple hierarchical layers based on the first set of neural network weights and one or more UE updates to the set of multiple hierarchical layers of the neural network, and means for receiving, from the one or more UE, a transmission and process the transmission through the set of multiple hierarchical layers of the neural network in accordance with the training.

A non-transitory computer-readable medium storing code for wireless communication at a network entity is described. The code may include instructions executable by a processor to transmit, to one or more UE, a first set of neural network weights corresponding to a first subset of a set of multiple hierarchical layers of a neural network, where the set of multiple hierarchical layers of the neural network are aggregated at different network entities and associated with different training frequencies in federated training, training, accord to a first frequency, a first layer of the set of multiple hierarchical layers based on the first set of neural network weights and one or more UE updates to the set of multiple hierarchical layers of the neural network, and receive, from the one or more UE, a transmission and process the transmission through the set of multiple hierarchical layers of the neural network in accordance with the training.

Some examples of the method, apparatuses, and non-transitory computer-readable medium described herein may further include operations, features, means, or instructions for receiving, from at least one UE of the one or more UE, at least a portion of a set of training data at the at least one UE.

In some examples of the method, apparatuses, and non-transitory computer-readable medium described herein, the portion of the set of training data includes CSI feedback.

Some examples of the method, apparatuses, and non-transitory computer-readable medium described herein may further include operations, features, means, or instructions for receiving the transmission from at least one UE of the one or more UE including a second set of neural network weights for the first layer, combining the second set of neural network weights for the at least one UE of the one or more UE, and training the first layer based on the combined second set of neural network weights, where the one or more UE updates include the combined second set of neural network weights.

In some examples of the method, apparatuses, and non-transitory computer-readable medium described herein, transmitting the first set of neural network weights may include operations, features, means, or instructions for determining the one or more UE may be part of a group of UE within a RU .

In some examples of the method, apparatuses, and non-transitory computer-readable medium described herein, the RU may be part of a group of RUs within a DU, and a second layer of the set of multiple hierarchical layers may be trained by the RU based on a set of training data from the UE, a set of training data at the RU, or both.

In some examples of the method, apparatuses, and non-transitory computer-readable medium described herein, the DU may be part of a group of DUs within a CU, and a third layer of the set of multiple hierarchical layers may be trained by the DU based on the set of training data at the UE, the set of training data at the RU, a set of training data at the DU, or any combination thereof.

In some examples of the method, apparatuses, and non-transitory computer-readable medium described herein, the CU may be part of a group of CUs within a CN, and a fourth layer of the set of multiple hierarchical layers may be trained by the CU based on the set of training data at the UE, the set of training data at the RU, the set of training data at the DU, a set of training data at the CU, or any combination thereof.

In some examples of the method, apparatuses, and non-transitory computer-readable medium described herein, processing the transmission may include operations, features, means, or instructions for decoding the transmission based on an auto-encoder, where the hierarchical layers may be trained at the auto-encoder based on a set of training data at the UE, a set of training data at the network entity, or both.

In some examples of the method, apparatuses, and non-transitory computer-readable medium described herein, a second layer of the set of multiple hierarchical layers may be associated with a first UE of the one or more UE and a third layer of the set of multiple hierarchical layers may be associated with a second UE of the one or more UE and the first layer, the second layer, and the third layer may be trained at the auto-encoder.

In some examples of the method, apparatuses, and non-transitory computer-readable medium described herein, the second layer, the third layer, or both may be an outermost layer of the set of multiple hierarchical layers trained at the auto-encoder, an innermost layer of the set of multiple hierarchical layers trained at the auto-encoder, or both.

### BRIEF DESCRIPTION OF THE DRAWINGS

FIGS. 1 and 2 illustrate examples of wireless communications systems that support layer-by-layer training for federated learning in accordance with aspects of the present disclosure.

FIGS. 3-5 illustrate examples of neural network diagrams that support layer-by-layer training for federated learning in accordance with aspects of the present disclosure.

FIG. 6 illustrates an example of a process flow that supports layer-by-layer training for federated learning in accordance with aspects of the present disclosure.

FIGS. 7 and 8 show block diagrams of devices that support layer-by-layer training for federated learning in accordance with aspects of the present disclosure.

FIG. 9 shows a block diagram of a communications manager that supports layer-by-layer training for federated learning in accordance with aspects of the present disclosure.

FIG. 10 shows a diagram of a system including a device that supports layer-by-layer training for federated learning in accordance with aspects of the present disclosure.

FIGS. 11 and 12 show block diagrams of devices that support layer-by-layer training for federated learning in accordance with aspects of the present disclosure.

FIG. 13 shows a block diagram of a communications manager that supports layer-by-layer training for federated learning in accordance with aspects of the present disclosure.

FIG. 14 shows a diagram of a system including a device that supports layer-by-layer training for federated learning in accordance with aspects of the present disclosure.

FIGS. 15 through 19 show flowcharts illustrating methods that support layer-by-layer training for federated learning in accordance with aspects of the present disclosure.

### DETAILED DESCRIPTION

In some wireless communications systems, one or more wireless devices may use a federated learning or federated training model to train a neural network or other machine learning process that is used to process data that is received or transmitted wirelessly. For example, a wireless device, such as a user equipment (UE) may obtain channel estimate measurements for a wireless channel and then use the neural network or machine learning process to compress the channel estimate measurements for more efficient transmission to one or more components of a base station or other network node.

Some layers of the machine learning process may be trained using training data from a specific device or user. Under the federated learning model, different users or devices may train and implement these layers separately from other devices or users. This hierarchy of machine learning layers may provide for efficient processing (e.g., channel estimation compression) by different wireless devices without exposing the data of one wireless device to another wireless device during the training process. For example, the federated learning model may be trained across multiple wireless devices, or clients, without private data for each wireless device being distributed across the wireless devices. However, one or more users may have statistically different local datasets that may negatively affect the performance, accuracy, or both of the federated learning model (e.g., a convergence rate while training the model).

As described herein, a wireless communications system may implement a hierarchical federated learning model to allow for training of neural network layers in the federated learning model in different places and at different cadences. For example, in a wireless communication system, such as an internet of things (IoT) system, different neural network layers of a federated learning model may be trained at a central network, a central unit, one or more distributed units, one or more radio units, or a combination thereof. Due to the granularity of training different neural network layers at different entities in a wireless communications system, the neural network layers may also be updated according to differing frequencies. For example, neural network layers that are considered more important, or that have higher data turnover, may be trained more frequently than other neural network layers. In some examples, one or more initial feature layers of a neural network may be fixed, while final layers of the neural network are updated. In some cases, one or more wireless devices may personalize (e.g., individually train) one or more layers of the federated learning model to tailor the federated learning model to an application at the wireless device. The wireless device may send an output of one or more personalized layers to a network, and the network may perform an inference based on one or more shared neural network layers, personalized neural network layers, the output, or a combination thereof. In some examples, an auto-encoder may apply a personalized federated learning model, where layers of the auto-encoder may be trained at different entities in a wireless communications system.

Aspects of the disclosure are initially described in the context of wireless communications systems. Aspects of the disclosure are further described in the context of neural network diagrams and process flows. Aspects of the disclosure are further illustrated by and described with reference to apparatus diagrams, system diagrams, and flowcharts that relate to layer-by-layer training for federated learning.

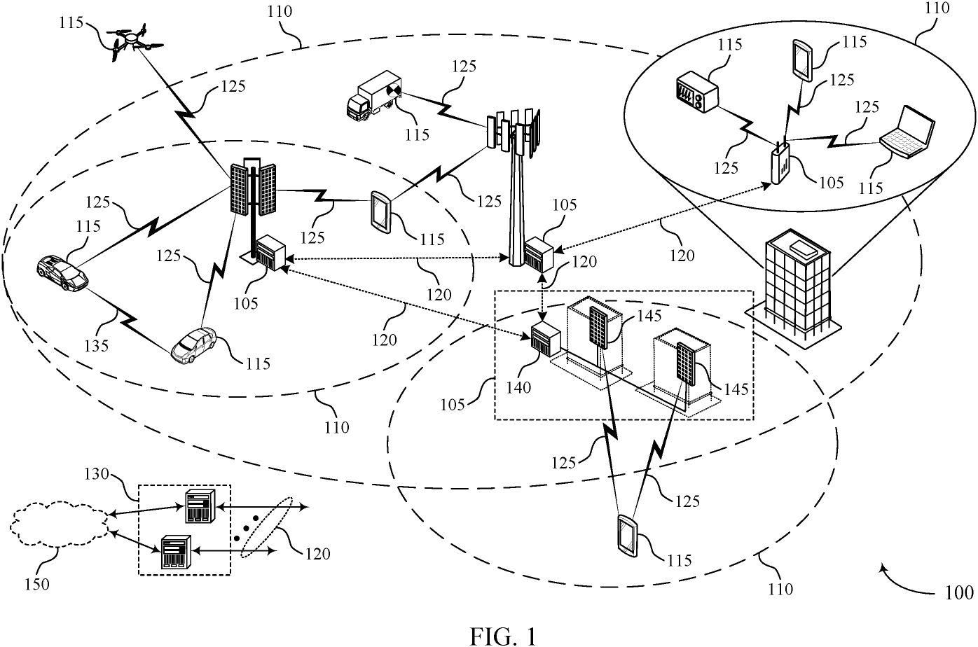

FIG. 1 illustrates an example of a wireless communications system 100 that supports layer-by-layer training for federated learning in accordance with aspects of the present disclosure. The wireless communications system 100 may include one or more network entities 105 (e.g., base stations), one or more UEs 115, and a core network (CN) 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The network entities 105 may be dispersed throughout a geographic area to form the wireless communications system 100 and may be devices in different forms or having different capabilities. The network entities 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., CN nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, network entity 105, entity of a CN 130, apparatus, device, or computing system configured to perform any techniques described herein. For example, a network node may be a UE 115. As another example, a network node may be a network entity 105. As another example, a first network node may be configured to communicate with a second network node or a third network node. In one aspect of this example, the first network node may be a UE 115, the second network node may be a network entity 105, and the third network node may be a UE 115. In another aspect of this example, the first network node may be a UE 115, the second network node may be a network entity 105, and the third network node may be a network entity 105. In yet other aspects of this example, the first, second, and third network nodes may be different. Similarly, reference to a UE 115, a network entity 105, an apparatus, a device, or a computing system may include disclosure of the UE 115, network entity 105, apparatus, device, or computing system being a network node. For example, disclosure that a UE 115 is configured to receive information from a network entity 105 also discloses that a first network node is configured to receive information from a second network node. In this example, consistent with this disclosure, the first network node may refer to a first UE 115, a first network entity 105, a first apparatus, a first device, or a first computing system configured to receive the information; and the second network node may refer to a second UE 115, a second network entity 105, a second apparatus, a second device, or a second computing system.

The network entities 105 may communicate with the CN 130, or with one another, or both. For example, the network entities 105 may interface with the CN 130 through one or more backhaul links 120 (e.g., via an S1, N2, N3, or other interface). The network entities 105 may communicate with one another over the backhaul links 120 (e.g., via an X2, Xn, or other interface) either directly (e.g., directly between network entities 105), or indirectly (e.g., via CN 130), or both. In some examples, the backhaul links 120 may be or include one or more wireless links.

One or more of the network entities 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a network entity 105, or downlink transmissions from a network entity 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ = ⅟(Δƒₘₐₓ ▪ N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entity 105. The wireless communications system 100 may include, for example, a heterogeneous network in which different types of the network entities 105 provide coverage for various geographic coverage areas 110 using the same or different radio access technologies.

The wireless communications system 100 may support synchronous or asynchronous operation. For synchronous operation, the network entities 105 may have similar frame timings, and transmissions from different network entities 105 may be approximately aligned in time. For asynchronous operation, the network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105) using vehicle-to-network (V2N) communications, or with both.

The CN 130 may provide user authentication, access authorization, tracking, Internet Protocol (IP) connectivity, and other access, routing, or mobility functions. The CN 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the CN 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a network entity 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or network entity 105 may be distributed across various network devices (e.g., radio heads and ANCs) or consolidated into a single network device (e.g., a network entity 105).

As described herein, a network entity 105 may include one or more components, such as network nodes or network entities, that are located at a single physical location or one or more components located at various physical locations. In examples in which the network entity 105 includes components that are located at various physical locations, the various components may each perform various functions such that, collectively, the various components achieve functionality that is similar to a network entity 105 that is located at a single physical location. As such, a network entity 105 described herein may equivalently refer to a standalone network entity 105 (also known as a monolithic base station) or a network entity 105 including components that are located at various physical locations or virtualized locations (also known as a disaggregated base station). In some implementations, such a network entity 105 including components that are located at various physical locations may be referred to as or may be associated with a disaggregated radio access network (RAN) architecture, such as an Open RAN (O-RAN) or Virtualized RAN (VRAN) architecture. In some implementations, such components of a network entity 105 may include or refer to one or more of a central unit (or centralized unit CU), a distributed unit (DU), or a radio unit (RU).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more network entity antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times in different directions. For example, the network entity 105 may transmit a signal according to different beamforming weight sets associated with different directions of transmission. Transmissions in different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a network entity 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the network entity 105 in different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured number of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a network entity 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the network entity 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a network entity 105 or a CN 130 supporting radio bearers for user plane data. At the physical layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a wireless device in wireless communication system 100, such as a UE 115, may use a neural network to process information transmitted to one or more components of a network entity 105, and the one or more components of the network entity 105 may use a complementary or otherwise related neural network to process the information received from the UE 115. For example, the UE 115 may use the neural network to compress channel estimate information collected by the UE 115 and transmit the compressed channel estimate information to the one or more components of the network entity 105. The one or more components of the network entity 105 may process the compressed channel estimate information received from the UE 115 through a corresponding neural network to decompress the channel estimate information or otherwise convert the compressed channel estimate information into a form that the network entity 105 can interpret.

As noted above, in such an example, training data for some layers of the neural network implemented at the UE 115 may come from different layers or components of the network, and training data for one or more other layers of the neural network implemented at the UE 115 may be originate at the UE 115. Thus, different layers of the neural network at the UE 115 may be trained according to a federated learning model, such that the devices may build a common model without sharing data between UEs 115.

The layers of the federated learning model may be trained according to different frequencies to reduce the negative affect of the different local datasets. In some cases, a network entity 105 may transmit one or more neural network weights for one or more initial feature layers that may be fixed for all UEs 115. In some cases, each UE 115 may train one or more layers of the neural network using data stored at the UE 115 according to a training frequency. The UEs 115 may transmit a neural network update to the network entity 105 based on training the layers that are specific to data stored at the UE. The neural network update may include a new set of weights for one or more layers of the neural network based on the training. One or more components of the network entity 105 may receive neural network updates from multiple UEs 115 and use these updates to train other layers of the neural network that are common to all UEs 115. In some cases, the UEs 115 may process a transmission using the trained neural network, such as by estimate channel conditions for the transmission using the neural network.

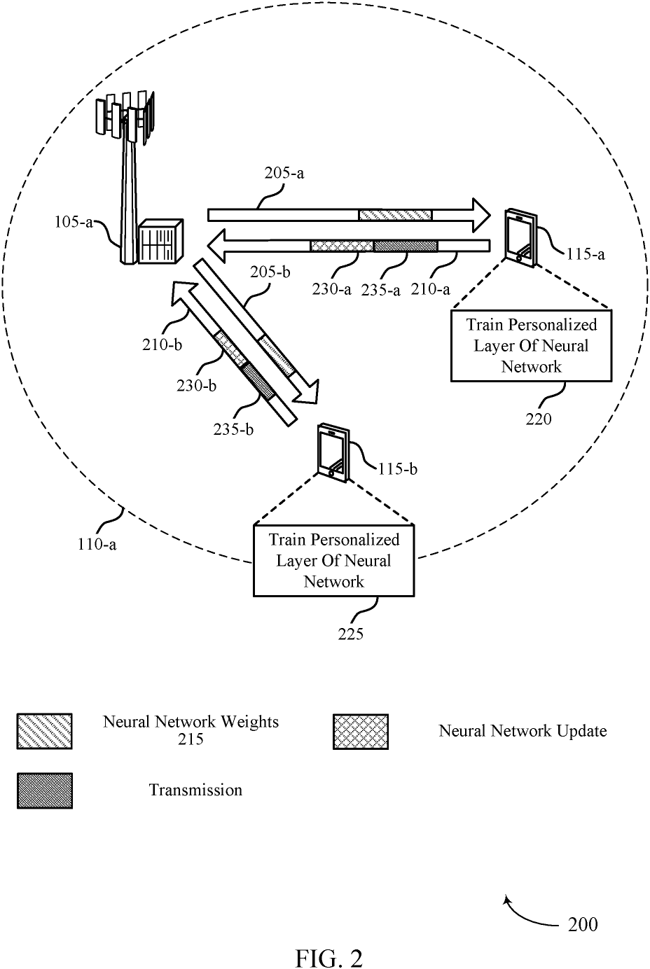

FIG. 2 illustrates an example of a wireless communications system 200 that supports layer-by-layer training for federated learning in accordance with aspects of the present disclosure. In some examples, wireless communications system 200 may implement aspects of wireless communications system 100 and may include a UE 115-a, a UE 115-b, and a network entity 105-a with a coverage area 110-a, which may be examples of UEs 115 and a network entity 105 with a coverage area 110 as described with reference to FIG. 1. In some examples, network entity 105-a and the UEs 115 may communicate control information, data, or both using a downlink communication link, such as downlink communication link 205-a for UE 115-a or downlink communication link 205-b for UE 115-b. Similarly, UE 115-a and UE 115-b may communicate control information, data or both with network entity 105-a using uplink communication link 210-a and an uplink communication link 210-b, respectively.

In some examples, UEs 115-a and 115-b may implement machine learning for processing one or more transmissions. For example, one or more components of the network entity 105-a, UE 115-a, and UE 115-b may train a neural network, and each device may use a version of the trained neural network to process a transmission (e.g., a message containing channel estimate information) for uplink or downlink. The network entity 105-a, UE 115-a, and UE 115-b may implement a federated learning model in which the neural network is trained across multiple devices (e.g., the network entity 105-a, UE 115-a, and UE 115-b) such that the devices may build a common model without sharing private data. UE 115-a and 115-b may be considered clients in the federated learning model, and may be mobile devices, IoT devices, or other wireless devices. Each UE 115-a, 115-b may have private data, which is data that may not be distributed or shared among UEs 115-a and 115-b. By implementing the federated learning model, the UEs 115-a and 115-b may maintain data privacy.

In some cases, UE 115-a, UE 115-b, and network entity 105-a may perform a number of passes of the training dataset to individually train the machine learning model before aggregation during training, which may be referred to as a local epoch. A communication bottleneck may occur during the training process, which UE 115-a, UE 115-b, and network entity 105-a may address by increasing a number of local epochs. In some examples, UE 115-a, UE 115-b, and network entity 105-a may implement a hierarchical federated learning process in which users may have different local datasets. The different datasets may negatively affect the performance regarding accuracy and convergence rate for a distributed learning model. Further, data heterogeneity may have a more profound impact when a number of local epochs is set to a large value to tackle communication overhead of federated learning. Thus, for hierarchical federated learning, different layers of a model may be trained in different locations, such as at different UEs 115, such as UE 115-a and UE 115-b. For example, a first layer may be trained at a CN, a second layer may be trained at a centralized unit (CU), a third layer may be trained at a distributed unit (DU), and a fourth layer may be trained at a radio unit (RU).

In some examples, if the layers are trained in different locations, they may also be trained according to different frequencies or in a distributive way in layer-wise granularity. For example, the initial feature layers may be fixed, while final layers may be updated at different UEs 115 according to different frequencies. In some cases, a network entity 105, such as network entity 105-a, may transmit one or more neural network weights 215 for one or more initial feature layers, which may also be referred to as shared layers, to UEs 115. Network entity 105-a may broadcast the neural network weights 215 to UE 115-a, UE 115-b, or both via downlink communication link 205-a and 205-b, respectively, in control signaling, data, or the like. The neural network weights 215 may be for a set of shared layers of a hierarchical federated learning neural network. Network entity 105-a may include a training frequency indication for each layer of the neural network, or the UEs 115 may be otherwise configured with the training frequencies for each layer of the neural network.

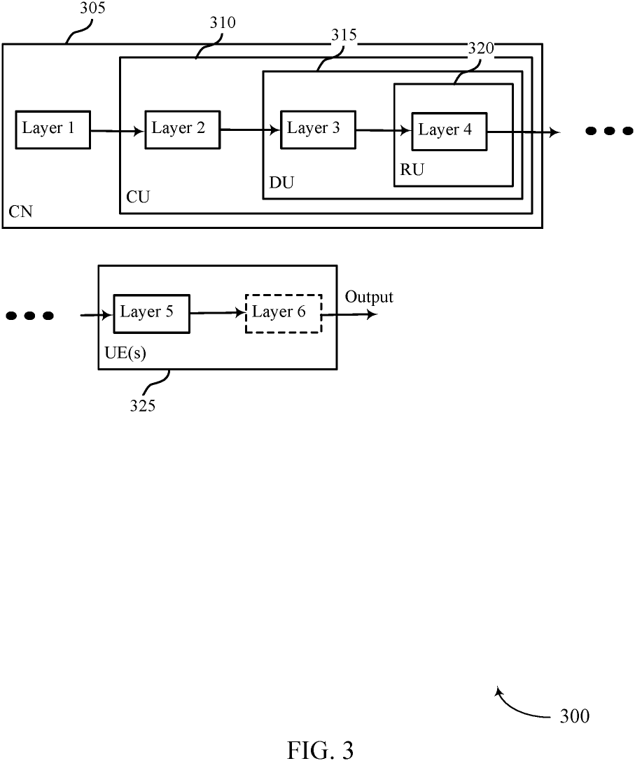

In some cases, each UE 115 may train one or more layers of the neural network using data stored at the UE 115, which may be referred to as UE-specific data. The UE-specific data may be private data, non-private data, or both. For example, at 220, UE 115-a may train one or more layers of the neural network using a set of UE-specific data for UE 115-a and the neural network weights 215. The one or more layers may be referred to as personalized layers (e.g., personalized due to being trained at a UE 115). The personalized layers may be shared layers between the network and the UE 115 or private layers at the UE 115. Similarly, at 225, UE 115-b may train one or more layers of the neural network using a set of UE-specific data for UE 115-b and the neural network weights 215. Once, UE 115-a, UE 115-b, or both have trained the personalized layers, UE 115-a, UE 115-b, or both may transmit a neural network update 230-a, and a neural network update 230-b, respectively, to network entity 105-a. The neural network update may include a new set of weights for the personalized layers based on the training at 220 and 225, or another indication of the training, which is described in further detail with respect to FIGS. 3-5.

In some cases, for a four layer neural network, layers 1, 2, and 3 may have weights fixed by a network entity, such as network entity 105-a. Network entity 105-a may transmit an indication of the neural network weights 215 for layers 1, 2, and 3 to UE 115-a and UE 115-b. UE 115-a and UE 115-b may independently train layer 4 using training data that may be UE specific, such as data that may be private at the UE 115, and the neural network weights 215 for layers 1, 2, and 3. In some cases, UE 115-a and UE 115-b may train layer 4 based on being within an RU, which is described in further detail with respect to FIGS. 3-5. In some cases, layers 1, 2, 3, and 4 may each be updated according to a different frequency. For example, layer 4 may be updated once every 100 ms, while layers 2 and 3 may be updated once every 1000 ms. In some examples, the neural network may have any number of layers, such that a UE 115 may train multiple layers.

In some examples, data may be sensed, stored, and processed by an end device, such as UE 115-a and UE 115-b. However, for some cases, there may be data at the network. For example, network entity 105-a may have application-dependent data. In some cases, UE 115-a, UE 115-b, or both may transmit information to network entity 105-a, such as a portion of UE-specific data. As an example, the portion of UE-specific data may include CSI feedback. By sharing a small portion of non-private data with network entity 105-a, UE 115-a, UE 115-b, or both may improve performance. For the four layer neural network, the shared layers may be trained according to the portion of the UE-specific data, which is described in further detail with respect to FIG. 3.

Once each layer of the neural network is trained at one or more UEs 115, and network entity 105-a receives neural network updates 230-a and 230-b from the one or more UEs 115, network entity 105-a may aggregate the training results of the UEs and update the neural network accordingly. The UEs 115-a and 115-b may send transmissions 235-a and 235-b that may be processed using the neural network to network entity 105-a. For example, UE 115-a may send transmission 235-a via uplink communication link 210-a, while UE 115-b may send transmission 235-b via uplink communication link 210-b. Network entity 105-a may process the transmissions 235-a and 235-b using the trained neural network at network entity 105-a.

FIG. 3 illustrates an example of a neural network diagram 300 that supports layer-by-layer training for federated learning in accordance with aspects of the present disclosure. In some examples, neural network diagram 300 may implement aspects of wireless communications system 100 and wireless communications system 200. For example, neural network diagram 300 may be implemented by a wireless communications system with a CN 305, one or more CUs 310, DUs 315, RUs 320, and UEs 325, which may be examples of UEs 115 as described with reference to FIGS. 1 and 2. A network entity may transmit a set of neural network weights to one or more UEs, which the UE may update according to a frequency using the set of neural network weights and UE-specific data, where the network entity may be a network entity 105 as described with reference to FIGS. 1 and 2.

Neural network diagram 300 may illustrate an example of a five or six layer neural network. However, a neural network may have any number of layers trained at any number of clients. For example, the neural network may be implemented in an IoT system, a V2X system, or in any other wireless communications system.

In some cases, one or more of the layers may have weights fixed by the network, while other layers may be trained for clients. For example, as illustrated in neural network diagram 300, layers 1, 2, 3, and 4 may have their weights fixed by the network, while layers 5 and 6 may be trained by one or more UEs 325 based on data at the UEs 325 and the weights of layers 1, 2, 3, and 4. Similarly, layers 1, 2, and 3 may have their weights fixed by the network, but layer 4 may be trained for UEs 325 within an RU 320 with the data in the UEs 325 and the weights of layers 1, 2, and 3. Layers 1 and 2 may have their weights fixed by the network, but layer 3 may be trained for RUs 320 within a DU 315 and associated UEs 325 with the data from the UEs 325 and the weights of layers 1 and 2. Layer 1 may have one or more weights fixed by the network, but layer 2 may be trained for DUs 315 within a CU 310 and associated RUs 320 and UEs 325 with the data from the UEs 325 and the weights of layer 1. Layer 1 may be trained for CUs 310 within a CN 305, and associate DUs 315, RUs 320, and UEs 325 with the data from the UEs 325.

In some examples, one or more UEs 325 may share a small portion of non-private data with the network. In such cases, layers 1, 2, and 3 may have weights fixed by the network, but layer 4 may be trained for UEs 325 within an RU 320 with the data from the UEs 325. Layers 1 and 2 may have their weights fixed by the network, but layer 3 may be trained for RUs 320 within the DU 315 and the associated UEs 325 with the data from the UEs 325 and RUs 320. Layer 1 may have weights fixed by the network, but layer 2 may be trained for DUs 315 within the CU 310 and the associated RUs 320 and UEs 325 with the data from the UEs 325, RUs 320, and DUs 315. Layer 1 may be trained for CUs 310 within the CN 305, and the associated DUs 315, RUs 320, and UEs 325 with the data from the UEs 325, RUs 320, DUs 315, and CUs 310.

In some examples, one or more UEs 325 may have layers, such as layer 5, layer 6, or both, that may not participate in the federated training at a network entity. The layers may be specialized for the UEs 325, and may be referred to as private layers. During training of the private or specialized layers, the UEs 325 may receive a broadcast including control signaling indicating one or more weights for shared layers of a neural network. For example, the UEs 325 may receive an indication of weights for layers 1, 2, 3, and 4. The UEs 325 may train layers 1, 2, 3, and 4 with their private layers, such as layer 5, layer 6, or both in subsequent training. The UEs 325 may transmit an indication of the trained shared layers back to a base station or other network entity. For example, the UEs 325 may transmit an update indication including one or more updated weights.

In some other examples, the UEs 325 may combine the parameters of the broadcasted shared layers with one or more parameters from personalized layers, such as trained shared layers, private layers, or both. The combining may include, for example, averaging the weights of the broadcasted shared layers with the weights of the trained corresponding layers, aggregating or concatenating the broadcasted weights for the shared layers with the weights from one or more other layers trained by the UEs 325 (e.g., personalized layers, such as trained shared layers, private layers, or both). The UEs 325 may train the model (e.g., layers 1 through 6) with the private layers and the combined parameters or weights. The UEs 325 may transmit an indication of the weights for the shared layers of the neural network based on training them according to the combined weights.

During inference, the UEs 325 may use shared layers for forward propagation based on receiving a broadcast indicating weights for the shared layers. The forward propagation of the shared layers may occur prior to application of the private layers. For example, the UEs 325 may apply shared layers 1, 2, 3, and 4 based on a recent broadcast indicating the shared layers prior to applying layer 5, layer 6, or both. In some cases, the UEs 325 may combine or aggregate the parameters of one or more shared layers with trained layers for forward propagation. Similarly, the forward propagation of the shared layers based on combining or aggregating the parameters may occur prior to the application of the private layers.

In some examples, UEs 325 may have multiple distinct copies of private layers, where each copy may be trained with different data instances. For example, layer 6 may be a copy of layer 5 trained with different data by a same UE 325. The different copies may be uniquely specialized for different resource blocks (RBs) within a same use case. The shared layers may remain the same for the different copies of the private layers. For example, for a frequency set f1, layer 1, layer 2, layer 3, layer 4, and layer 5 may be updated according to f1. For a different frequency set f2, layer 1, layer 2, layer 3, layer 4, and layer 5 may be updated according to f2. Similarly, the different copies may be uniquely specialized for different use cases, such as a use case A and a use case B. For use case A, layer 1, layer 2, layer 3, layer 4, and layer 5 may be a first copy, A. For use case B, layer 1, layer 2, layer 3, layer 4, and layer 5 may be a different copy, B.

In some examples, UEs 325 may train private layers where the inference may be performed at the network, such as at a network entity or base station. For example, for layer 6, inference may happen at a network entity, although both layer 5 and layer 6 are trained for each UE 325 (e.g., private layers). In some cases, the UEs 325 may receive a broadcast indicating the shared layers (e.g., layers 1, 2, 3, and 4) and may train the shared layers with the private layers 5 and 6 to create personalized layers 1 through 6. In some other cases, the UEs 325 may combine (e.g., aggregate) the parameters or weights of the shared layers with the weights of the layers trained by the UEs 325. Then, the UEs 325 may train the overall model with the private layers 5 and 6. In both cases, the UEs 325 may transmit an indication of one or more of the personalized layers to the network (e.g., new weights for shared layers 1, 2, 3, and 4 based on training them with private layers 5 and 6).

In some examples, an inference procedure may be split between the network and the UEs 325. For example, the UEs 325 may use the broadcasted shared layers for forward propagation before layer 5. The UEs 325 may send the output of layer 5 to the network. Inference for layer 6 may occur at the network. In some other examples, the UEs 325 may combine the parameters or weights of the shared layers with the weights of layers trained by the UEs 325 for forward propagation before layer 5. The UEs 325 may send the output of layer 5 to the network. Inference for layer 6 may occur at the network.

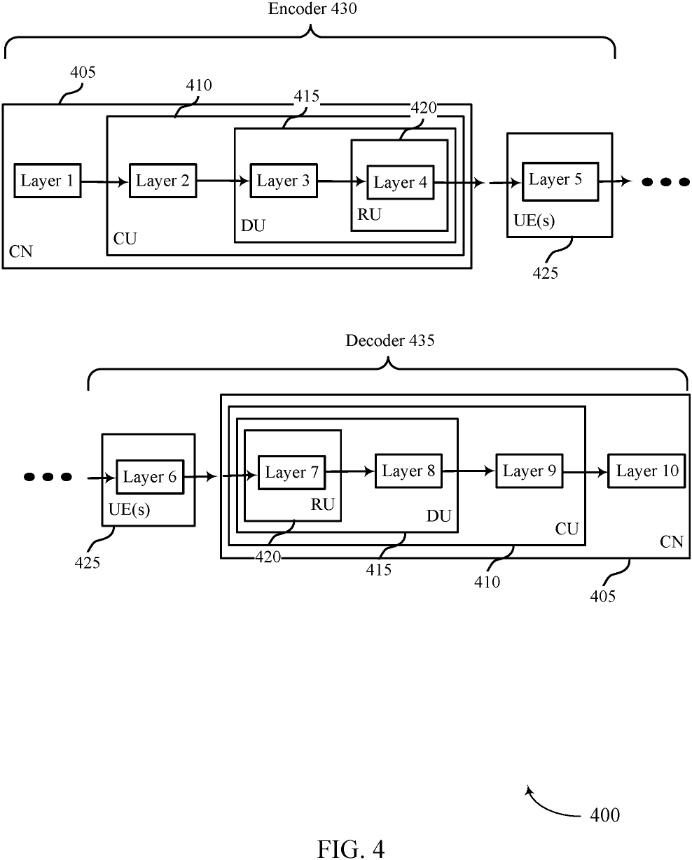

FIG. 4 illustrates an example of a neural network diagram 400 that supports layer-by-layer training for federated learning in accordance with aspects of the present disclosure. In some examples, neural network diagram 400 may implement aspects of wireless communications system 100, wireless communications system 200, neural network diagram 300, or a combination thereof. For example, neural network diagram 400 may be implemented with a CN 405, one or more CUs 410, DUs 415, RUs 420, and UEs 425, which may be examples of UEs 115 as described with reference to FIGS. 1 and 2. A network entity, UE 425, or both may implement an autoencoder for performing hierarchical federated learning, where the network entity may be a network entity 105 as described with reference to FIGS. 1 and 2.

Neural network diagram 400 may illustrate an example of a ten layer neural network implemented at an auto-encoder including an encoder 430 and decoder 435. However, a neural network may have any number of layers trained at any number of clients. For example, the neural network may be implemented in an IoT system, a V2X system, or in any other wireless communications system.

In some examples, a wireless device (e.g., a UE 425 or a network entity) may implement auto-encoders for handling communications. An auto-encoder may be an example of a neural network system that modulates and demodulates a message or transmission. Additionally or alternatively, an autoencoder may encode and decode a message. The auto-encoder may support modulating, demodulating, or both at a sequence-based level or a symbol-based level. The neural network of the autoencoder may be trained using machine learning techniques to determine efficient data encodings (e.g., using federating learning techniques as described with reference to FIGS. 2 and 3). The auto-encoder may include an encoder 430, which may be a neural network-based encoder, and a decoder 435, which may be a neural network-based decoder. The auto-encoder may be used to compress a channel estimate at a UE 425. For example, the encoder 430 may compress a channel estimate at the UEs 425, and a decoder 435 may be used to decompress the channel estimate at a network entity.

In some cases, one or more of the layers may have weights fixed by the network, while other layers may be trained for clients. For example, as illustrated in neural network diagram 400, layers 1, 2, 3, and 4 at the encoder 430 and layers 7, 8, 9, and 10 at the decoder 435 may have their weights fixed by the network, while layer 5 of the encoder 430 and layer 6 of the decoder 435 may be trained by one or more UEs 425. Similarly, layers 1, 2, and 3 of the encoder 430 and layers 8, 9, and 10 of the decoder 435 may have their weights fixed by the network, but layer 4 of the encoder 430 and layer 7 of the decoder 435 may be trained for UEs 425 within an RU 420 with the data in the UEs 425. Layers 1 and 2 of the encoder 430 and layers 9 and 10 of the decoder 435 may have their weights fixed by the network, but layer 3 of the encoder 430 and layer 8 of the decoder 435 may be trained for RUs 420 within a DU 415 and associated UEs 425 with the data from the UEs 425. Layer 1 of the encoder 430 and layer 10 of the decoder 435 may have one or more weights fixed by the network, but layer 2 of the encoder 430 and layer 9 of the decoder 435 may be trained for DUs 415 within a CU 410 and associated RUs 420 and UEs 425 with the data from the UEs 425. Layer 1 of the encoder 430 and layer 10 of the decoder 435 may be trained for CUs 410 within a CN 405, and associate DUs 415, RUs 420, and UEs 425 with the data from the UEs 425.

In some examples, each UE 425 may have private layers for the encoder 430 and the decoder 435. For example, layer 5 for the encoder 430 and layer 6 for the decoder 435 may be private to UEs 425. The UEs 425 may receive a broadcast indication of shared layers, and may train the shared layers with the private layers to create one or more personalized layers (e.g., the trained shared layers, the private layers, or both). For example, the UEs 425 may receive an indication of weights for layers 1, 2, 3, and 4 of the encoder 430, and may train the layers 1, 2, 3, and 4 with a private layer, layer 5. Similarly, the UEs 425 may receive an indication of weights for layers 7, 8, 9, and 10 of the decoder 435, and may train the layers 7, 8, 9, and 10 with the private layer, layer 6. In some other examples, the UEs 425 may combine (e.g., aggregate) one or more parameters or weights of the shared layers with weights of layers trained at the UEs 425 (e.g., personalized layers). The UEs 425 may train the overall model with the private layers (e.g., layers 5 and 6). The UEs 425 may transmit an indication of the personalized layers (e.g., personalized shared layers) to a network entity based on training the model with the private layers.

In some examples, the UEs 425 may use a broadcasted indication of shared layers 1, 2, 3, and 4 for forward propagation before layer 5. The UEs 425 may send the output of layer 5 to the network. Inference for layers 6, 7, 8, 9, and 10 may happen at the network. In some other examples, the UEs 425 may combine (e.g., aggregate) the parameters or weights of the shared layers with the weights of layers trained at the UEs 425 for forward propagation before layer 5. The UEs 425 may send the output of layer 5 to the network. Inference for layers 6, 7, 8, 9, and 10 may happen at the network.

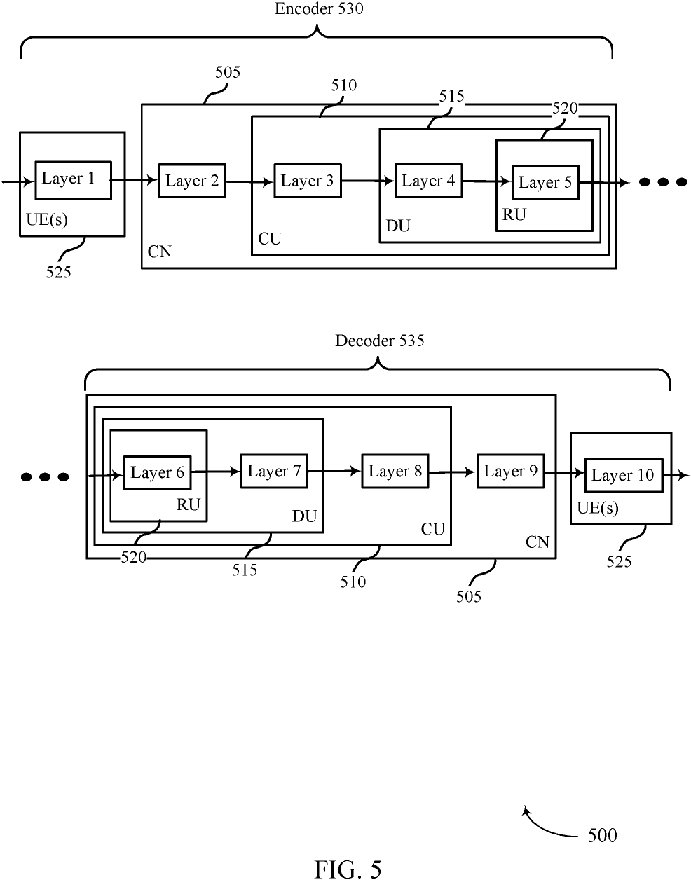

FIG. 5 illustrates an example of a neural network diagram 500 that supports layer-by-layer training for federated learning in accordance with aspects of the present disclosure. In some examples, neural network diagram 500 may implement aspects of wireless communications system 100, wireless communications system 200, neural network diagram 300, or a combination thereof. For example, neural network diagram 500 may be implemented by a wireless communications system with a CN 505, one or more CUs 510, DUs 515, RUs 520, and UEs 525, which may be examples of UEs 115 as described with reference to FIGS. 1 and 2. A network entity, UE 525, or both may implement an autoencoder for performing hierarchical federated learning, where the network entity may be a network entity 105 as described with reference to FIGS. 1 and 2.

Neural network diagram 500 may illustrate an example of a ten layer neural network implemented at an auto-encoder including an encoder 530 and decoder 535, which may be an example of an encoder 430 and decoder 435 as described with reference to FIG. 4. A neural network may have any number of layers trained at any number of clients. For example, the neural network may be implemented in an IoT system, a V2X system, or in any other wireless communications system.

In some cases, one or more of the layers may have weights fixed by the network, while other layers may be trained for clients. For example, as illustrated in neural network diagram 500, layers 1, 2, 3, and 4 at the encoder 530 and layers 7, 8, 9, and 10 at the decoder 535 may have their weights fixed by the network, while layer 5 of the encoder 530 and layer 6 of the decoder 535 may be trained by one or more UEs 525. Similarly, layers 1, 2, and 3 of the encoder 530 and layers 8, 9, and 10 of the decoder 535 may have their weights fixed by the network, but layer 4 of the encoder 530 and layer 7 of the decoder 535 may be trained for UEs 525 within an RU 520 with the data in the UEs 525. Layers 1 and 2 of the encoder 530 and layers 9 and 10 of the decoder 535 may have their weights fixed by the network, but layer 3 of the encoder 530 and layer 8 of the decoder 535 may be trained for RUs 520 within a DU 515 and associated UEs 525 with the data from the UEs 525. Layer 1 of the encoder 530 and layer 10 of the decoder 535 may have one or more weights fixed by the network, but layer 2 of the encoder 530 and layer 9 of the decoder 535 may be trained for DUs 515 within a CU 510 and associated RUs 520 and UEs 525 with the data from the UEs 525. Layer 1 of the encoder 530 and layer 10 of the decoder 535 may be trained for CUs 510 within a CN 505, and associate DUs 515, RUs 520, and UEs 525 with the data from the UEs 525.

In some examples, each UE 525 may train an outermost layer for personalization for the encoder 530 and decoder 535. For example, layer 1 of the encoder 530 and layer 10 of the decoder 535 may be unique to UEs 525, and may be referred to as private layers, while layers 2, 3, 4, 5, 6, 7, 8, and 9 may be shared from a network entity, such as a network entity. The UEs 525 may receive a broadcast indication of the shared layers, and may train the shared layers with the private layers. For example, the UEs 525 may receive an indication of weights for layers 2, 3, 4, and 5 of the encoder 530, and may train the layers 2, 3, 4, and 5 with the private layer, layer 1. Similarly, the UEs 525 may receive an indication of weights for layers 6, 7, 8, and 9 of the decoder 535, and may train the layers 6, 7, 8, and 9 with the private layer, layer 10. In some other examples, the UEs 525 may combine (e.g., aggregation) one or more parameters or weights of the shared layers with weights of layers trained at the UEs 525, which may be referred to as personalized layers. The UEs 525 may train the overall model with the private layers (e.g., layers 1 and 10). The UEs 525 may transmit an indication of the personalized shared layers (e.g., layers 2 through 9 trained with layers 1 and 10) to a network entity based on training the model with the private layers.

In some examples, the UEs 525 may use a broadcasted indication of shared layers 2, 3, 4, and 5 for forward propagation after layer 1. The UEs 525 may send the output of layer 5 to the network. Inference for layers 6, 7, 8, 9, and 10 may happen at the network. In some other examples, the UEs 525 may combine (e.g., aggregate) the parameters or weights of the shared layers with the weights of layers trained at the UEs 525 for forward propagation before layer 5. The UEs 525 may send the output of layer 5 to the network. Inference for layers 6, 7, 8, 9, and 10 may happen at the network.

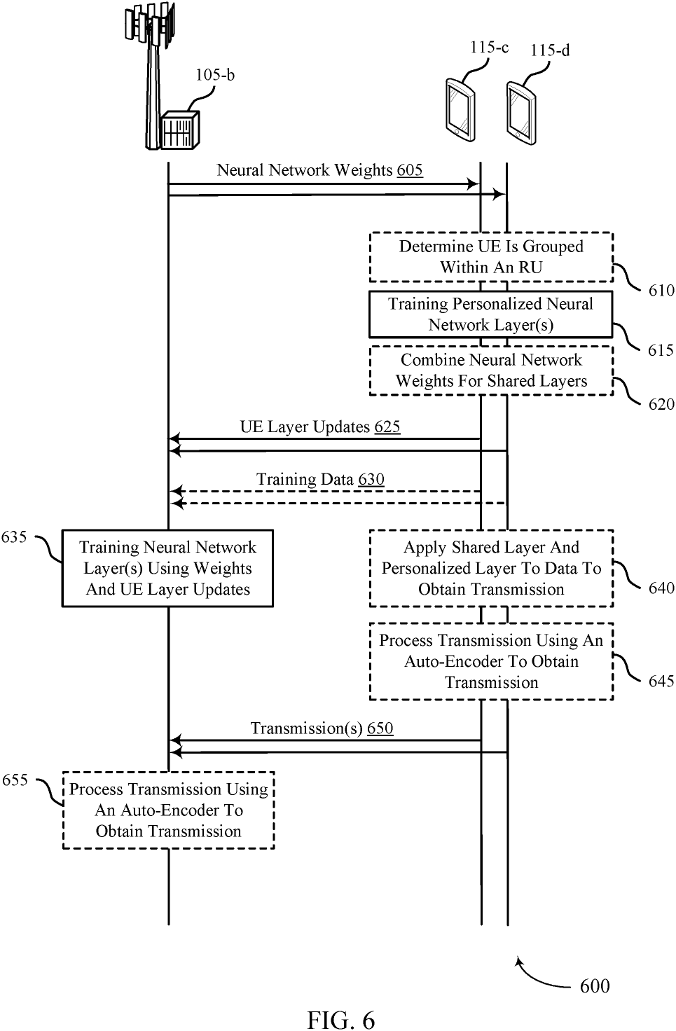

FIG. 6 illustrates an example of a process flow 600 that supports layer-by-layer training for federated learning in accordance with aspects of the present disclosure. In some examples, the process flow 600 may implement aspects of wireless communications system 100, wireless communications system 200, and neural network diagram 300 through neural network diagram 500. The process flow 600 may illustrate an example of one or more UEs 115 updating a neural network using personalized layers according to different frequencies. Network entity 105-b, UE 115-c, and UE 115-d may be examples of a network entity 105 and UEs 115 as described with reference to FIGS. 1 and 2. Alternative examples of the following may be implemented, where some processes are performed in a different order than described or are not performed. In some cases, processes may include additional features not mentioned below, or further processes may be added.

At 605, network entity 105-b may transmit a set of neural network weights to one or more UEs 115, such as UE 115-c, UE 115-d, or both. The neural network weights may be for a set of shared layers, such as hierarchical layers of a neural network. The different layers may be aggregated at different network entities and trained according to different frequencies.

At 610, UE 115-c, UE 115-d, or both may determine they are grouped within a RU. In some cases, UE 115-c, UE 115-d, or both may be part of a group of UEs 115 within the RU. The UEs 115 may train a layer of the neural network based on being within the RU and using UE data. The RU may be part of a group of RUs within a DU, and the RU may train another layer of the neural network based on the set of training data at the UEs 115, a set of training data at the RU, or both. The DU may be part of a group of DUs within a CU, and the DU may train an additional layer of the neural network based on the set of training data at the UEs 115, the set of training data at the RU, a set of training data at the DU, or any combination thereof. The CU may be part of a group of CUs within a CN, and the CU may train an additional layer of the neural network based on the set of training data at the UEs 115, the set of training data at the RU, the set of training data at the DU, a set of training data at the CU, or any combination thereof.

At 615, UE 115-c and UE 115-d may each train one or more personalized layers of the neural network according to a training frequency, where the personalized layers include one or more shared layers, one or more private layers, or both. For example, UE 115-c and UE 115-d may train one or more shared layers with one or more private layers to create new personalized shared layers. UE 115-c and UE 115-d may use the set of neural network weights and a set of training data at UE 115-c and UE 115-d, respectively, to train the personalized layers. In some examples, UE 115-c, UE 115-d, or both may train one or more copies of the private layers according to a training frequency, where each copy may be trained using additional training data (e.g., different training data) or for a different use case.

At 620, UE 115-c, UE 115-d, or both may combine the set of neural network weights for the shared layers and another set of neural network weights produced from training the shared layers using private layers to obtain a combined set of neural network weights. The combining may include aggregating the weights. UE 115-c, UE 115-d, or both may train the hierarchical layers of the neural network based on the combined set of neural network weights and the set of training data at the UE, the training producing an additional set of neural network weights.

At 625, UE 115-c, UE 115-d, or both may transmit one or more UE layer updates based on training the personalized layers. For example, UE 115-c, UE 115-d, or both may transmit the additional set of neural network weights based on training the neural network using the combined set of neural network weights. Additionally or alternatively, UE 115-c, UE 115-d, or both may train the shared layers based on training one or more private layers to create one or more personalized shared layers, and may transmit the new weights for the personalized shared layers to network entity 105-b based on the training.

At 630, UE 115-c, UE 115-d, or both may transmit at least a portion of the set of training data at UE 115-c, UE 115-d, or both. The portion of the set of training data may include CSI feedback.

At 635, network entity 105-b may train the neural network based on the neural network weights and the UE updates to the layers of the neural network.

At 640, UE 115-c, UE 115-d, or both may apply one or more personalized shared layers to a set of data at an initial time. Subsequently, UE 115-c, UE 115-d, or both may apply one or more private layers to the set of data to obtain a transmission. In some examples, UE 115-c, UE 115-d, or both may combine a set of neural network weights for shared layers and a set of neural network weights produced from training the personalized layers (e.g., the personalize shared layers, private layers, or both) to obtain a combined, concatenated, or aggregated, set of neural network weights. UE 115-c, UE 115-d, or both may apply one or more personalized shared layers to a set of data at an initial time, where the personalized shared layers are trained using the combined set of neural network weights. The combining may include aggregating the weights. UE 115-c, UE 115-d, or both may subsequently apply the private layers to the set of data to obtain the transmission.

At 645, UE 115-c, UE 115-d, or both may process the transmission using an auto-encoder. The hierarchical layers may be trained at the auto-encoder based on the set of training data at the UE, a set of training data at the network entity, or both. The private layers may be an outermost layer of the layers trained at the auto-encoder or an innermost layer of the layers trained at the auto-encoder.

At 650, UE 115-c, UE 115-d, or both may perform a transmission to network entity 105-b (e.g., based on obtaining the transmission at 640). The transmission may be processed at UE 115-c, UE 115-d, or both through the hierarchical layers of the neural network.

At 655, network entity 105-b may receive the transmission and may process the transmission through the hierarchical layers of the neural network.

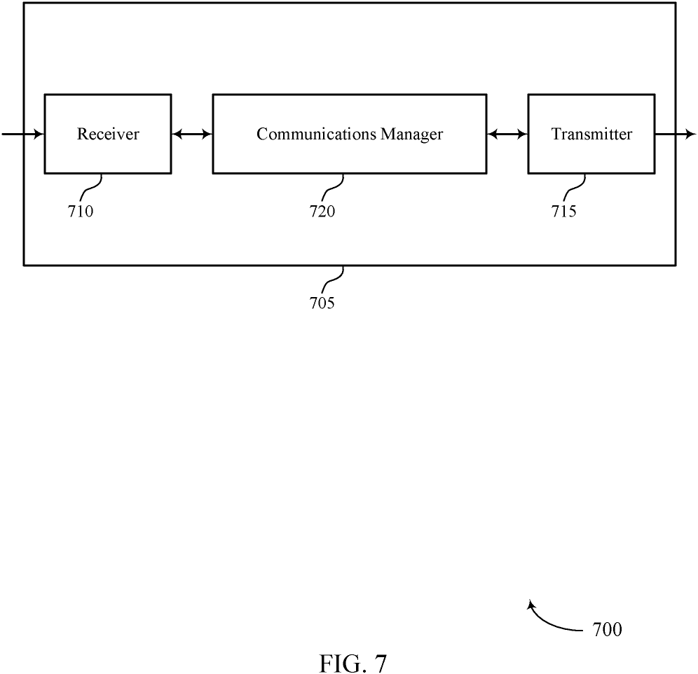

FIG. 7 shows a block diagram 700 of a device 705 that supports layer-by-layer training for federated learning in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to layer-by-layer training for federated learning). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to layer-by-layer training for federated learning). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of layer-by-layer training for federated learning as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. For example, the communications manager 720 may be configured as or otherwise support a means for receiving, from a network entity, a first set of neural network weights corresponding to a first subset of hierarchical layers of a set of multiple hierarchical layers of a neural network, where different layers in the set of multiple hierarchical layers of the neural network are aggregated at different network entities and associated with different training frequencies in federated training. The communications manager 720 may be configured as or otherwise support a means for training, according to a first training frequency, a first layer of the set of multiple hierarchical layers based on the first set of neural network weights and a set of training data at the UE, where the first layer is outside of or does not belong to the first subset of hierarchical layers. The communications manager 720 may be configured as or otherwise support a means for performing a transmission to the network entity, where the transmission is processed at the UE through the set of multiple hierarchical layers of the neural network in accordance with the training.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for one or more wireless devices to train and implement a federated learning neural network that may be trained at different devices according to different frequencies, which may provide for reduced processing, reduced power consumption, more efficient utilization of communication resources, and the like.

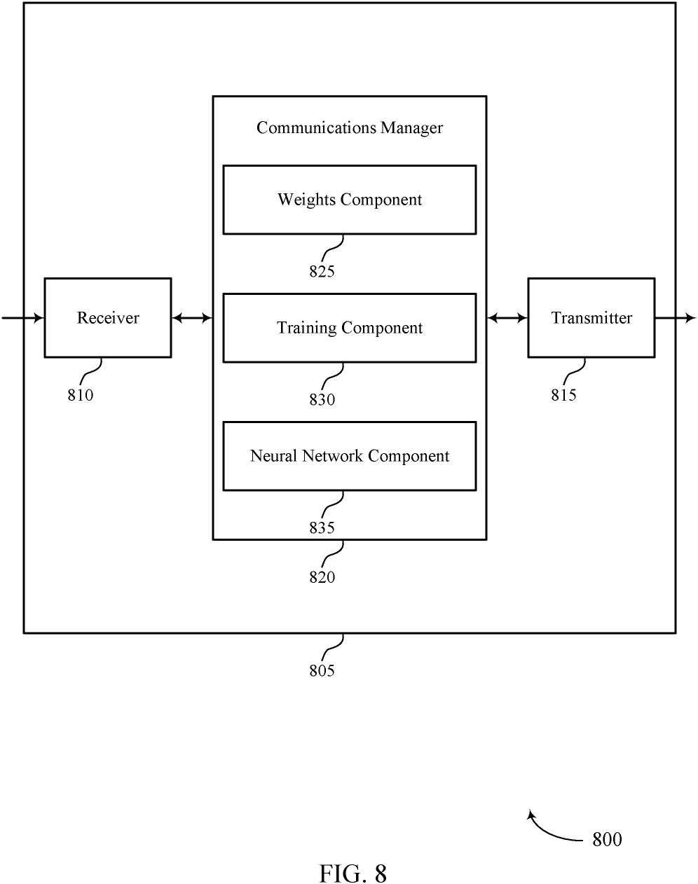

FIG. 8 shows a block diagram 800 of a device 805 that supports layer-by-layer training for federated learning in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to layer-by-layer training for federated learning). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to layer-by-layer training for federated learning). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of layer-by-layer training for federated learning as described herein. For example, the communications manager 820 may include a weights component 825, a training component 830, a neural network component 835, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. The weights component 825 may be configured as or otherwise support a means for receiving, from a network entity, a first set of neural network weights corresponding to a first subset of hierarchical layers of a set of multiple hierarchical layers of a neural network, where different layers in the set of multiple hierarchical layers of the neural network are aggregated at different network entities and associated with different training frequencies in federated training. The training component 830 may be configured as or otherwise support a means for training, according to a first training frequency, a first layer of the set of multiple hierarchical layers based on the first set of neural network weights and a set of training data at the UE, where the first layer is outside of or does not belong to the first subset of hierarchical layers. The neural network component 835 may be configured as or otherwise support a means for performing a transmission to the network entity, where the transmission is processed at the UE through the set of multiple hierarchical layers of the neural network in accordance with the training.

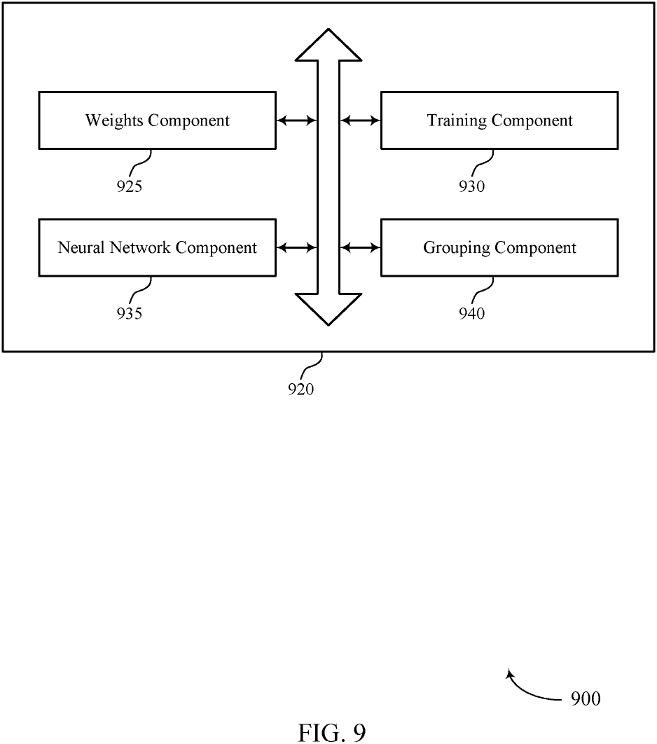

FIG. 9 shows a block diagram 900 of a communications manager 920 that supports layer-by-layer training for federated learning in accordance with aspects of the present disclosure. The communications manager 920 may be an example of aspects of a communications manager 720, a communications manager 820, or both, as described herein. The communications manager 920, or various components thereof, may be an example of means for performing various aspects of layer-by-layer training for federated learning as described herein. For example, the communications manager 920 may include a weights component 925, a training component 930, a neural network component 935, a grouping component 940, or any combination thereof. Each of these components may communicate, directly or indirectly, with one another (e.g., via one or more buses).

The communications manager 920 may support wireless communication at a UE in accordance with examples as disclosed herein. The weights component 925 may be configured as or otherwise support a means for receiving, from a network entity, a first set of neural network weights corresponding to a first subset of hierarchical layers of a set of multiple hierarchical layers of a neural network, where different layers in the set of multiple hierarchical layers of the neural network are aggregated at different network entities and associated with different training frequencies in federated training. The training component 930 may be configured as or otherwise support a means for training, according to a first training frequency, a first layer of the set of multiple hierarchical layers based on the first set of neural network weights and a set of training data at the UE, where the first layer is outside of or does not belong to the first subset of hierarchical layers. The neural network component 935 may be configured as or otherwise support a means for performing a transmission to the network entity, where the transmission is processed at the UE through the set of multiple hierarchical layers of the neural network in accordance with the training.

In some examples, the training component 930 may be configured as or otherwise support a means for transmitting, to the network entity, at least a portion of the set of training data at the UE, where the portion of the set of training data includes, for example, CSI feedback.

In some examples, the training component 930 may be configured as or otherwise support a means for training a second layer of the set of multiple hierarchical layers based on training the first layer and the set of training data at the UE, where the first set of neural network weights corresponds to the second layer. In some examples, the weights component 925 may be configured as or otherwise support a means for transmitting, to the network entity, a second set of neural network weights for the second layer based on training the second layer.

In some examples, the weights component 925 may be configured as or otherwise support a means for combining the first set of neural network weights corresponding to a second layer of the set of multiple hierarchical layers and a second set of neural network weights produced from training the first layer to obtain a combined set of neural network weights. In some examples, the training component 930 may be configured as or otherwise support a means for training the set of multiple hierarchical layers of the neural network based on the combined set of neural network weights and the set of training data at the UE, the training producing a third set of neural network weights. In some examples, the weights component 925 may be configured as or otherwise support a means for performing the transmission to the network entity including the third set of neural network weights based on training the set of multiple hierarchical layers.

In some examples, to support performing the transmission, the neural network component 935 may be configured as or otherwise support a means for applying, at a first time, a second layer of the set of multiple hierarchical layers to a set of data, where the first set of neural network weights corresponds to the second layer. In some examples, to support performing the transmission, the neural network component 935 may be configured as or otherwise support a means for applying, at a second time after the first time, the first layer to the set of data to obtain the transmission.

In some examples, to support performing the transmission, the weights component 925 may be configured as or otherwise support a means for combining the first set of neural network weights corresponding to a second layer of the set of multiple hierarchical layers and a second set of neural network weights produced from training the first layer to obtain a combined set of neural network weights. In some examples, to support performing the transmission, the neural network component 935 may be configured as or otherwise support a means for applying, at a first time, a second layer of the set of multiple hierarchical layers to a set of data, where the second layer is trained according to the combined set of neural network weights. In some examples, to support performing the transmission, the neural network component 935 may be configured as or otherwise support a means for applying, at a second time after the first time, the first layer to the set of data to obtain the transmission.

In some examples, the training component 930 may be configured as or otherwise support a means for training, according to a second training frequency, one or more copies of the first layer of the set of multiple hierarchical layers based on the first set of neural network weights and an additional set of training data at the UE.

In some examples, to support training the first layer, the grouping component 940 may be configured as or otherwise support a means for determining the UE is part of a group of UEs within a RU.

In some examples, the RU is part of a group of RUs within a DU, and a second layer of the set of multiple hierarchical layers is trained by the RU based on the set of training data at the UE, a set of training data at the RU, or both.

In some examples, the DU is part of a group of DUs within a CU, and a third layer of the set of multiple hierarchical layers is trained by the DU based on the set of training data at the UE, the set of training data at the RU, a set of training data at the DU, or any combination thereof.

In some examples, the CU is part of a group of CUs within a CN, and a fourth layer of the set of multiple hierarchical layers is trained by the CU based on the set of training data at the UE, the set of training data at the RU, the set of training data at the DU, a set of training data at the CU, or any combination thereof.

In some examples, the neural network component 935 may be configured as or otherwise support a means for processing the transmission using an auto-encoder, where the hierarchical layers are trained at the auto-encoder based on the set of training data at the UE, a set of training data at the network entity, or both.

In some examples, the first layer is an outermost layer of the set of multiple hierarchical layers trained at the auto-encoder, an innermost layer of the set of multiple hierarchical layers trained at the auto-encoder, or both.

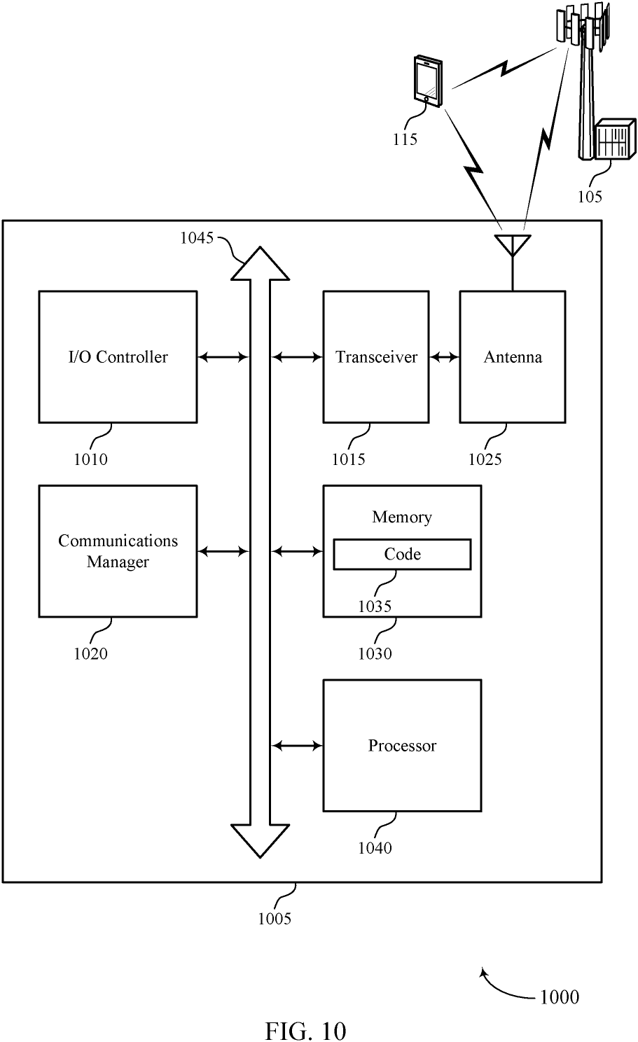

FIG. 10 shows a diagram of a system 1000 including a device 1005 that supports layer-by-layer training for federated learning in accordance with aspects of the present disclosure. The device 1005 may be an example of or include the components of a device 705, a device 805, or a UE 115 as described herein. The device 1005 may communicate wirelessly with one or more network entities 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting layer-by-layer training for federated learning). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving, from a network entity, a first set of neural network weights corresponding to a first subset of hierarchical layers of a set of multiple hierarchical layers of a neural network, where different layers in the set of multiple hierarchical layers of the neural network are aggregated at different network entities and associated with different training frequencies in federated training. The communications manager 1020 may be configured as or otherwise support a means for training, according to a first training frequency, a first layer of the set of multiple hierarchical layers based on the first set of neural network weights and a set of training data at the UE, where the first layer is outside of or does not belong to the first subset of hierarchical layers. The communications manager 1020 may be configured as or otherwise support a means for performing a transmission to the network entity, where the transmission is processed at the UE through the set of multiple hierarchical layers of the neural network in accordance with the training.

By including or configuring the communications manager 1020 in accordance with examples as described herein, the device 1005 may support techniques for one or more wireless devices to train and implement a federated learning neural network that may be trained at different devices according to different frequencies, which may provide for improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of layer-by-layer training for federated learning as described herein, or the processor 1040 and the memory 1030 may be otherwise configured to perform or support such operations.

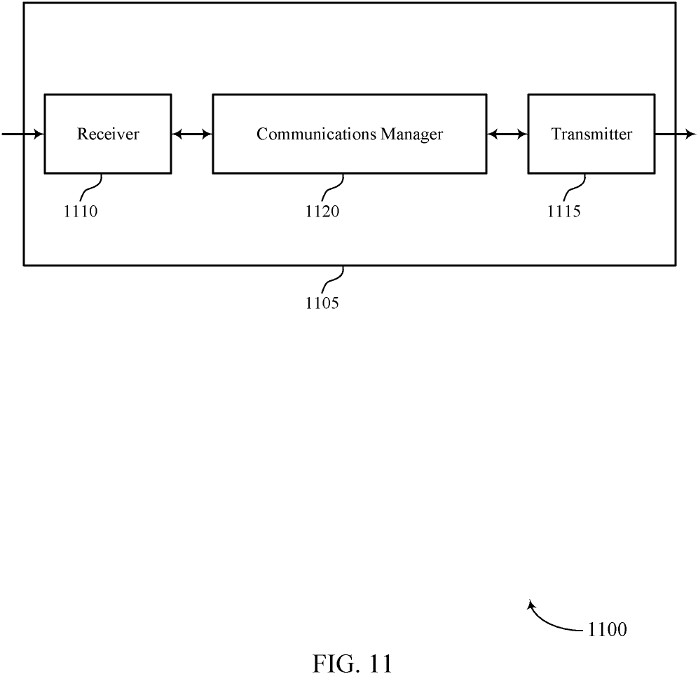

FIG. 11 shows a block diagram 1100 of a device 1105 that supports layer-by-layer training for federated learning in accordance with aspects of the present disclosure. The device 1105 may be an example of aspects of a network entity as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to layer-by-layer training for federated learning). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to layer-by-layer training for federated learning). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of layer-by-layer training for federated learning as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a network entity in accordance with examples as disclosed herein. For example, the communications manager 1120 may be configured as or otherwise support a means for transmitting, to one or more UE, a first set of neural network weights corresponding to a first subset of hierarchical layers of a set of multiple hierarchical layers of a neural network, where different layers in the set of multiple hierarchical layers of the neural network are aggregated at different network entities and associated with different training frequencies in federated training. The communications manager 1120 may be configured as or otherwise support a means for training, according to a first frequency, a first layer of the set of multiple hierarchical layers based on the first set of neural network weights and one or more UE updates to the set of multiple hierarchical layers of the neural network. The communications manager 1120 may be configured as or otherwise support a means for receiving, from the one or more UE, a transmission and processing the transmission through the set of multiple hierarchical layers of the neural network in accordance with the training.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for one or more wireless devices to train and implement a federated learning neural network that may be trained at different devices according to different frequencies, which may provide for reduced processing, reduced power consumption, more efficient utilization of communication resources, and the like.

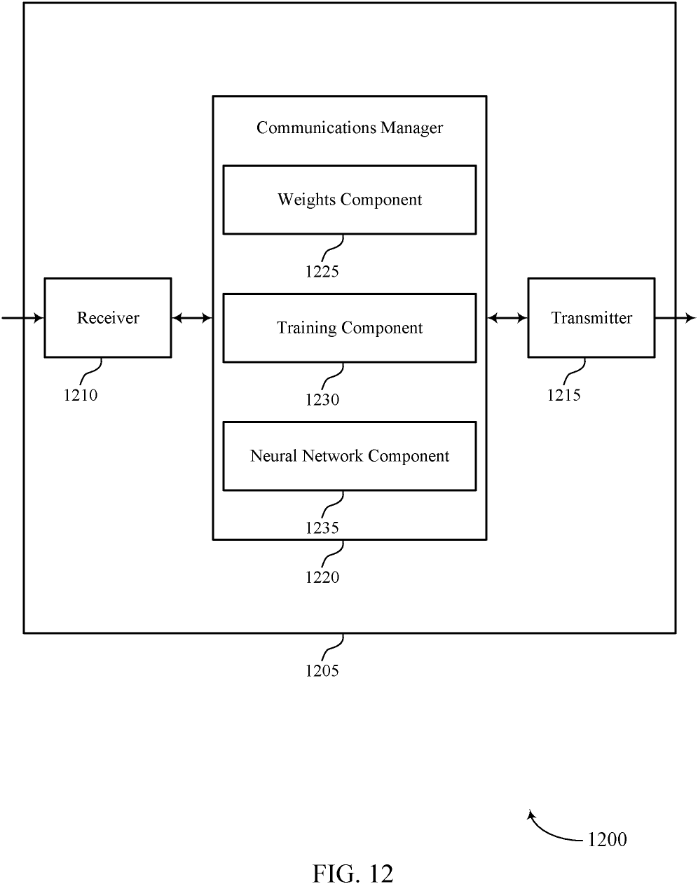

FIG. 12 shows a block diagram 1200 of a device 1205 that supports layer-by-layer training for federated learning in accordance with aspects of the present disclosure. The device 1205 may be an example of aspects of a device 1105 or a network entity as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to layer-by-layer training for federated learning). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to layer-by-layer training for federated learning). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of layer-by-layer training for federated learning as described herein. For example, the communications manager 1220 may include a weights component 1225, a training component 1230, a neural network component 1235, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a network entity in accordance with examples as disclosed herein. The weights component 1225 may be configured as or otherwise support a means for transmitting, to one or more UE, a first set of neural network weights corresponding to a first subset of hierarchical layers of a set of multiple hierarchical layers of a neural network, where different layers in the set of multiple hierarchical layers of the neural network are aggregated at different network entities and associated with different training frequencies in federated training. The training component 1230 may be configured as or otherwise support a means for training, according to a first frequency, a first layer of the set of multiple hierarchical layers based on the first set of neural network weights and one or more UE updates to the set of multiple hierarchical layers of the neural network. The neural network component 1235 may be configured as or otherwise support a means for receiving, from the one or more UE, a transmission and processing the transmission through the set of multiple hierarchical layers of the neural network in accordance with the training.

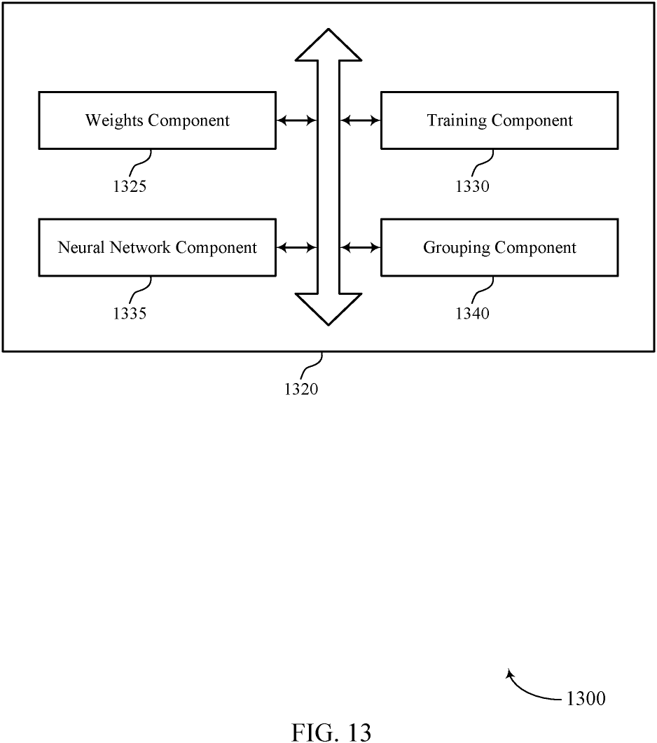

FIG. 13 shows a block diagram 1300 of a communications manager 1320 that supports layer-by-layer training for federated learning in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of layer-by-layer training for federated learning as described herein. For example, the communications manager 1320 may include a weights component 1325, a training component 1330, a neural network component 1335, a grouping component 1340, or any combination thereof. Each of these components may communicate, directly or indirectly, with one another (e.g., via one or more buses).

The communications manager 1320 may support wireless communication at a network entity in accordance with examples as disclosed herein. The weights component 1325 may be configured as or otherwise support a means for transmitting, to one or more UE, a first set of neural network weights corresponding to a first subset of hierarchical layers of a set of multiple hierarchical layers of a neural network, where different layers in the set of multiple hierarchical layers of the neural network are aggregated at different network entities and associated with different training frequencies in federated training. The training component 1330 may be configured as or otherwise support a means for training, according to a first frequency, a first layer of the set of multiple hierarchical layers based on the first set of neural network weights and one or more UE updates to the set of multiple hierarchical layers of the neural network. The neural network component 1335 may be configured as or otherwise support a means for receiving, from the one or more UE, a transmission and processing the transmission through the set of multiple hierarchical layers of the neural network in accordance with the training.

In some examples, the training component 1330 may be configured as or otherwise support a means for receiving, from at least one UE of the one or more UE, at least a portion of a set of training data at the at least one UE, where the portion of the set of training data includes CSI feedback.

In some examples, the weights component 1325 may be configured as or otherwise support a means for receiving the transmission from at least one UE of the one or more UE including a second set of neural network weights for the first layer. In some examples, the weights component 1325 may be configured as or otherwise support a means for combining the second set of neural network weights for the at least one UE of the one or more UE. In some examples, the training component 1330 may be configured as or otherwise support a means for training the first layer based on the combined second set of neural network weights, where the one or more updates include the combined second set of neural network weights.

In some examples, to support transmitting the first set of neural network weights, the grouping component 1340 may be configured as or otherwise support a means for determining the one or more UE are part of a group of UE within a RU.

In some examples, the RU is part of a group of RUs within a DU, and a second layer of the set of multiple hierarchical layers is trained by the RU based on the set of training data at the UE, a set of training data at the RU, or both.

In some examples, the DU is part of a group of DUs within a CU, and a third layer of the set of multiple hierarchical layers is trained by the DU based on the set of training data at the UE, the set of training data at the RU, a set of training data at the DU, or any combination thereof.

In some examples, the CU is part of a group of CUs within a CN, and a fourth layer of the set of multiple hierarchical layers is trained by the CU based on the set of training data at the UE, the set of training data at the RU, the set of training data at the DU, a set of training data at the CU, or any combination thereof.

In some examples, the neural network component 1335 may be configured as or otherwise support a means for processing the transmission using an auto-encoder, where the hierarchical layers are trained at the auto-encoder based on the set of training data at the UE, a set of training data at the network entity, or both.

In some examples, a second layer of the set of multiple hierarchical layers is associated with a first UE of the one or more UE and a third layer of the set of multiple hierarchical layers is associated with a second UE of the one or more UE, the first layer, the second layer, and the third layer are trained at the auto-encoder.

In some examples, the second layer, the third layer, or both are an outermost layer of the set of multiple hierarchical layers trained at the auto-encoder, an innermost layer of the set of multiple hierarchical layers trained at the auto-encoder, or both.

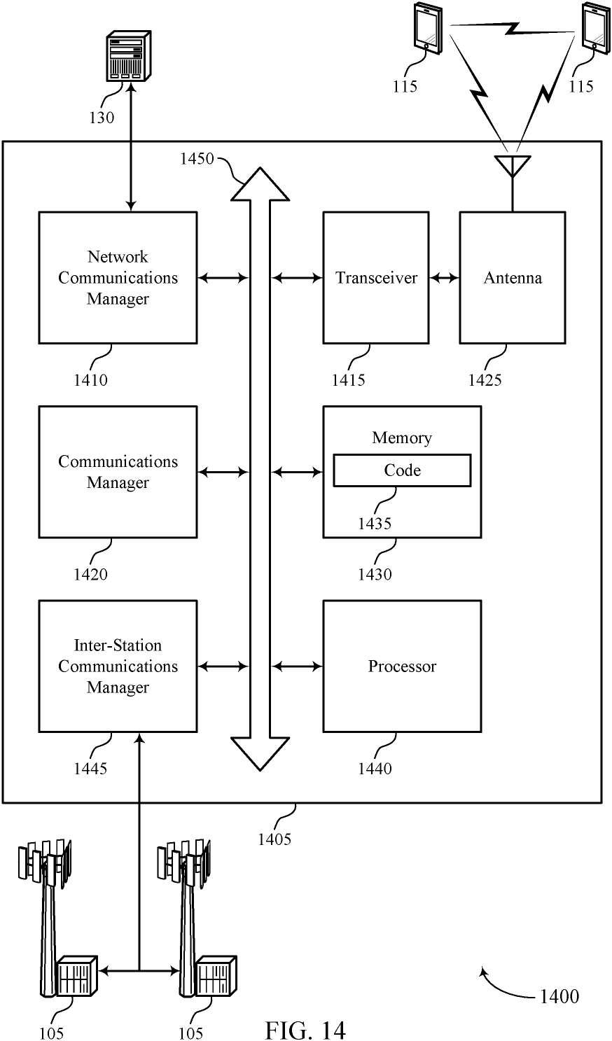

FIG. 14 shows a diagram of a system 1400 including a device 1405 that supports layer-by-layer training for federated learning in accordance with aspects of the present disclosure. The device 1405 may be an example of or include the components of a device 1105, a device 1205, or a network entity as described herein. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a CN 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting layer-by-layer training for federated learning). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other network entities 105, and may include a controller or scheduler for controlling communications with UEs 115 in cooperation with other network entities 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for transmitting, to one or more UE, a first set of neural network weights corresponding to a first subset of hierarchical layers of a set of multiple hierarchical layers of a neural network, where different layers in the set of multiple hierarchical layers of the neural network are aggregated at different network entities and associated with different training frequencies in federated training. The communications manager 1420 may be configured as or otherwise support a means for training, according to a first frequency, a first layer of the set of multiple hierarchical layers based on the first set of neural network weights and one or more UE updates to the set of multiple hierarchical layers of the neural network. The communications manager 1420 may be configured as or otherwise support a means for receiving, from the one or more UE, a transmission and processing the transmission through the set of multiple hierarchical layers of the neural network in accordance with the training.

By including or configuring the communications manager 1420 in accordance with examples as described herein, the device 1405 may support techniques for one or more wireless devices to train and implement a federated learning neural network that may be trained at different devices according to different frequencies, which may provide for improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of layer-by-layer training for federated learning as described herein, or the processor 1440 and the memory 1430 may be otherwise configured to perform or support such operations.

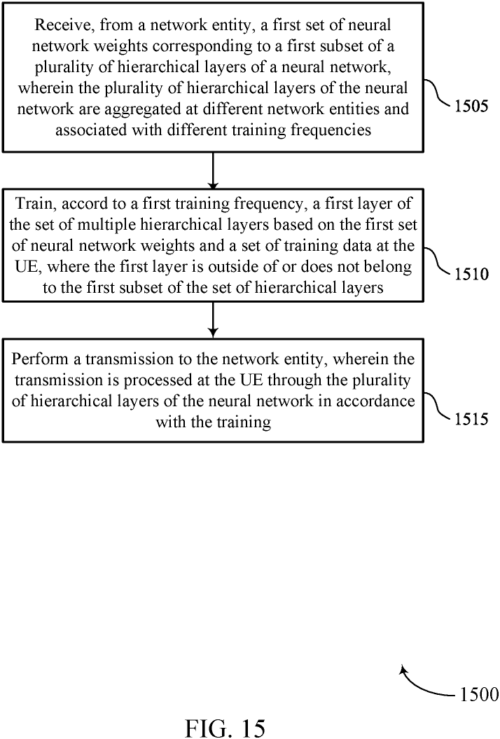

FIG. 15 shows a flowchart illustrating a method 1500 that supports layer-by-layer training for federated learning in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1505, the method may include receiving, from a network entity, a first set of neural network weights corresponding to a first subset of a set of multiple hierarchical layers of a neural network, where the set of multiple hierarchical layers of the neural network are aggregated at different network entities and associated with different training frequencies in federated training. The operations of 1505 may be performed in accordance with examples as disclosed herein. In some examples, aspects of the operations of 1505 may be performed by a weights component 925 as described with reference to FIG. 9.

At 1510, the method may include training, according to a first training frequency, a first layer of the set of multiple hierarchical layers based on the first set of neural network weights and a set of training data at the UE, where the first layer is outside of or does not belong to the first subset of the set of hierarchical layers. The operations of 1510 may be performed in accordance with examples as disclosed herein. In some examples, aspects of the operations of 1510 may be performed by a training component 930 as described with reference to FIG. 9.

At 1515, the method may include performing a transmission to the network entity, where the transmission is processed at the UE through the set of multiple hierarchical layers of the neural network in accordance with the training. The operations of 1515 may be performed in accordance with examples as disclosed herein. In some examples, aspects of the operations of 1515 may be performed by a neural network component 935 as described with reference to FIG. 9.

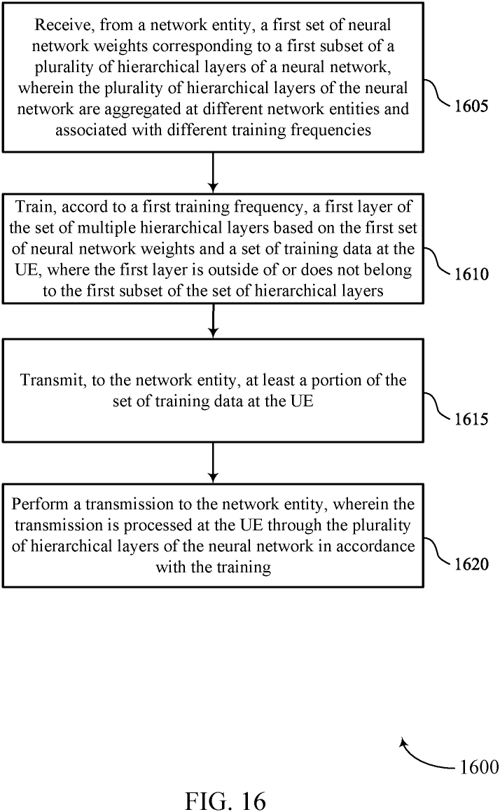

FIG. 16 shows a flowchart illustrating a method 1600 that supports layer-by-layer training for federated learning in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1605, the method may include receiving, from a network entity, a first set of neural network weights corresponding to a first subset of hierarchical layers of a set of multiple hierarchical layers of a neural network, where the set of multiple hierarchical layers of the neural network are aggregated at different network entities and associated with different training frequencies in federated training. The operations of 1605 may be performed in accordance with examples as disclosed herein. In some examples, aspects of the operations of 1605 may be performed by a weights component 925 as described with reference to FIG. 9.

At 1610, the method may include training, according to a first training frequency, a first layer of the set of multiple hierarchical layers based on the first set of neural network weights and a set of training data at the UE, where the first layer is outside of or does not belong to the first subset of hierarchical layers. The operations of 1610 may be performed in accordance with examples as disclosed herein. In some examples, aspects of the operations of 1610 may be performed by a training component 930 as described with reference to FIG. 9.

At 1615, the method may include transmitting, to the network entity, at least a portion of the set of training data at the UE. In some examples, the portion of the set of training data includes CSI feedback. The operations of 1615 may be performed in accordance with examples as disclosed herein. In some examples, aspects of the operations of 1615 may be performed by a training component 930 as described with reference to FIG. 9.

At 1620, the method may include performing a transmission to the network entity, where the transmission is processed at the UE through the set of multiple hierarchical layers of the neural network in accordance with the training. The operations of 1620 may be performed in accordance with examples as disclosed herein. In some examples, aspects of the operations of 1620 may be performed by a neural network component 935 as described with reference to FIG. 9.

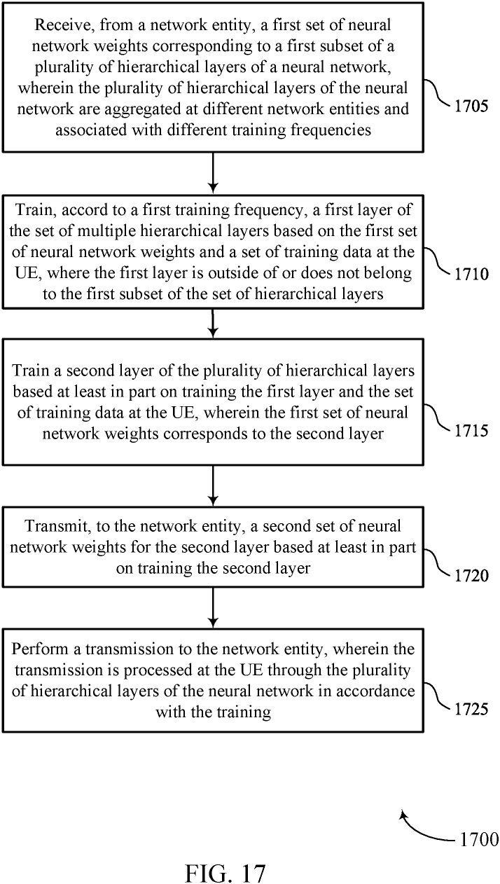

FIG. 17 shows a flowchart illustrating a method 1700 that supports layer-by-layer training for federated learning in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1705, the method may include receiving, from a network entity, a first set of neural network weights corresponding to a first subset of hierarchical layers of a set of multiple hierarchical layers of a neural network, where the set of multiple hierarchical layers of the neural network are aggregated at different network entities and associated with different training frequencies in federated training. The operations of 1705 may be performed in accordance with examples as disclosed herein. In some examples, aspects of the operations of 1705 may be performed by a weights component 925 as described with reference to FIG. 9.

At 1710, the method may include training, according to a first training frequency, a first layer of the set of multiple hierarchical layers based on the first set of neural network weights and a set of training data at the UE, where the first layer is outside of or does not belong to the first subset of hierarchical layers. The operations of 1710 may be performed in accordance with examples as disclosed herein. In some examples, aspects of the operations of 1710 may be performed by a training component 930 as described with reference to FIG. 9.

At 1715, the method may include training a second layer of the set of multiple hierarchical layers based on training the first layer and the set of training data at the UE, where the first set of neural network weights corresponds to the second layer. The operations of 1715 may be performed in accordance with examples as disclosed herein. In some examples, aspects of the operations of 1715 may be performed by a training component 930 as described with reference to FIG. 9.

At 1720, the method may include transmitting, to the network entity, a second set of neural network weights for the second layer based on training the second layer. The operations of 1720 may be performed in accordance with examples as disclosed herein. In some examples, aspects of the operations of 1720 may be performed by a weights component 925 as described with reference to FIG. 9.

At 1725, the method may include performing a transmission to the network entity, where the transmission is processed at the UE through the set of multiple hierarchical layers of the neural network in accordance with the training. The operations of 1725 may be performed in accordance with examples as disclosed herein. In some examples, aspects of the operations of 1725 may be performed by a neural network component 935 as described with reference to FIG. 9.

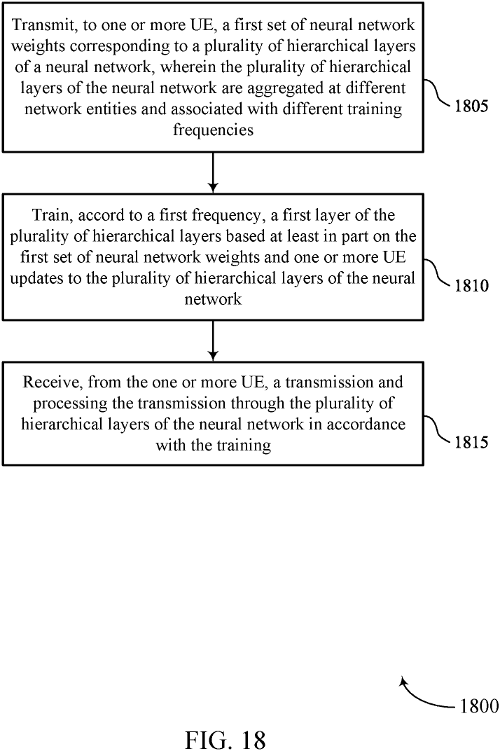

FIG. 18 shows a flowchart illustrating a method 1800 that supports layer-by-layer training for federated learning in accordance with aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally or alternatively, the network entity may perform aspects of the described functions using special-purpose hardware.

At 1805, the method may include transmitting, to one or more UE, a first set of neural network weights corresponding to a first subset of hierarchical layers of a set of multiple hierarchical layers of a neural network, where the set of multiple hierarchical layers of the neural network are aggregated at different network entities and associated with different training frequencies in federated training. The operations of 1805 may be performed in accordance with examples as disclosed herein. In some examples, aspects of the operations of 1805 may be performed by a weights component 1325 as described with reference to FIG. 13.

At 1810, the method may include training, according to a first frequency, a first layer of the set of multiple hierarchical layers based on the first set of neural network weights and one or more UE updates to the set of multiple hierarchical layers of the neural network. The operations of 1810 may be performed in accordance with examples as disclosed herein. In some examples, aspects of the operations of 1810 may be performed by a training component 1330 as described with reference to FIG. 13.

At 1815, the method may include receiving, from the one or more UE, a transmission and processing the transmission through the set of multiple hierarchical layers of the neural network in accordance with the training. The operations of 1815 may be performed in accordance with examples as disclosed herein. In some examples, aspects of the operations of 1815 may be performed by a neural network component 1335 as described with reference to FIG. 13.

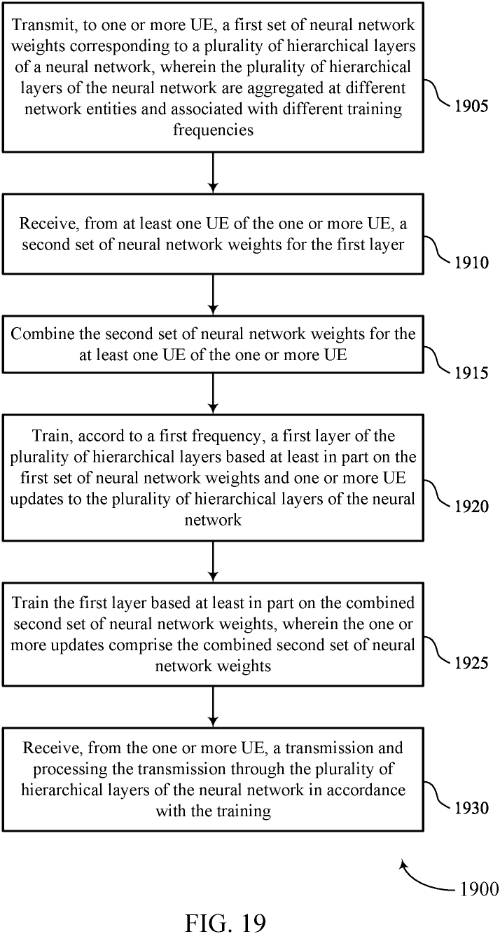

FIG. 19 shows a flowchart illustrating a method 1900 that supports layer-by-layer training for federated learning in accordance with aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally or alternatively, the network entity may perform aspects of the described functions using special-purpose hardware.

At 1905, the method may include transmitting, to one or more UE, a first set of neural network weights corresponding to a first subset of hierarchical layers of a set of multiple hierarchical layers of a neural network, where the set of multiple hierarchical layers of the neural network are aggregated at different network entities and associated with different training frequencies in federated training. The operations of 1905 may be performed in accordance with examples as disclosed herein. In some examples, aspects of the operations of 1905 may be performed by a weights component 1325 as described with reference to FIG. 13.

At 1910, the method may include receiving the transmission from at least one UE of the one or more UE including a second set of neural network weights for the first layer. The operations of 1910 may be performed in accordance with examples as disclosed herein. In some examples, aspects of the operations of 1910 may be performed by a weights component 1325 as described with reference to FIG. 13.

At 1915, the method may include combining the second set of neural network weights for the at least one UE of the one or more UE. The operations of 1915 may be performed in accordance with examples as disclosed herein. In some examples, aspects of the operations of 1915 may be performed by a weights component 1325 as described with reference to FIG. 13.

At 1920, the method may include training, according to a first frequency, a first layer of the set of multiple hierarchical layers based on the first set of neural network weights and one or more UE updates to the set of multiple hierarchical layers of the neural network. The operations of 1920 may be performed in accordance with examples as disclosed herein. In some examples, aspects of the operations of 1920 may be performed by a training component 1330 as described with reference to FIG. 13.

At 1925, the method may include training the first layer based on the combined second set of neural network weights, where the one or more updates include the combined second set of neural network weights. The operations of 1925 may be performed in accordance with examples as disclosed herein. In some examples, aspects of the operations of 1925 may be performed by a training component 1330 as described with reference to FIG. 13.

At 1930, the method may include receiving, from the one or more UE, a transmission and processing the transmission through the set of multiple hierarchical layers of the neural network in accordance with the training. The operations of 1930 may be performed in accordance with examples as disclosed herein. In some examples, aspects of the operations of 1930 may be performed by a neural network component 1335 as described with reference to FIG. 13.

The following provides an overview of aspects of the present disclosure:

Aspect 1: A method for wireless communication at a UE, comprising: receiving, from a network entity, a first set of neural network weights corresponding to a first subset of a plurality of hierarchical layers of a neural network, wherein the plurality of hierarchical layers of the neural network are aggregated at different network entities and associated with different training frequencies in federated training; training, according to a first training frequency, a first layer of the plurality of hierarchical layers based at least in part on the first set of neural network weights and a set of training data at the UE, wherein the first layer is outside of the first subset of the plurality of hierarchical layers; and performing a transmission to the network entity, wherein the transmission is processed at the UE through the plurality of hierarchical layers of the neural network in accordance with the training.

Aspect 2: The method of aspect 1, further comprising: transmitting, to the network entity, at least a portion of the set of training data at the UE.

Aspect 3: The apparatus of aspect 2, wherein the portion of the set of training data comprises channel state information feedback.

Aspect 4: The method of any of aspects 1 through 3, further comprising: training a second layer of the plurality of hierarchical layers based at least in part on training the first layer and the set of training data at the UE, wherein the first set of neural network weights corresponds to the second layer; and transmitting, to the network entity, a second set of neural network weights for the second layer based at least in part on training the second layer.

Aspect 5: The method of any of aspects 1 through 4, further comprising: combining the first set of neural network weights corresponding to a second layer of the plurality of hierarchical layers and a second set of neural network weights produced from training the first layer to obtain a combined set of neural network weights; training the plurality of hierarchical layers of the neural network based at least in part on the combined set of neural network weights and the set of training data at the UE, the training producing a third set of neural network weights; and performing the transmission to the network entity comprising the third set of neural network weights based at least in part on training the plurality of hierarchical layers.

Aspect 6: The method of any of aspects 1 through 5, further comprising: applying, at a first time, a second layer of the plurality of hierarchical layers to a set of data, wherein the first set of neural network weights corresponds to the second layer; and applying, at a second time after the first time, the first layer to the set of data to obtain the transmission.

Aspect 7: The method of any of aspects 1 through 6, further comprising: combining the first set of neural network weights corresponding to a second layer of the plurality of hierarchical layers and a second set of neural network weights produced from training the first layer to obtain a combined set of neural network weights; applying, at a first time, a second layer of the plurality of hierarchical layers to a set of data, wherein the second layer is trained according to the combined set of neural network weights; and applying, at a second time after the first time, the first layer to the set of data to obtain the transmission.

Aspect 8: The method of any of aspects 1 through 7, further comprising: training, according to a second training frequency, one or more copies of the first layer of the plurality of hierarchical layers based at least in part on the first set of neural network weights and an additional set of training data at the UE.

Aspect 9: The method of any of aspects 1 through 8, further comprising: determining the UE is part of a group of UEs within a radio unit.

Aspect 10: The method of aspect 9, wherein the radio unit is part of a group of radio units within a distributed unit, and a second layer of the plurality of hierarchical layers is trained by the radio unit based at least in part on the set of training data at the UE, a set of training data at the radio unit, or both.

Aspect 11: The method of aspect 10, wherein the distributed unit is part of a group of distributed units within a centralized unit, and a third layer of the plurality of hierarchical layers is trained by the distributed unit based at least in part on the set of training data at the UE, the set of training data at the radio unit, a set of training data at the distributed unit, or any combination thereof.

Aspect 12: The method of aspect 11, wherein the centralized unit is part of a group of centralized units within a core network, and a fourth layer of the plurality of hierarchical layers is trained by the centralized unit based at least in part on the set of training data at the UE, the set of training data at the radio unit, the set of training data at the distributed unit, a set of training data at the centralized unit, or any combination thereof.

Aspect 13: The method of any of aspects 1 through 12, further comprising: processing the transmission using an auto-encoder, wherein the hierarchical layers are trained at the auto-encoder based at least in part on the set of training data at the UE, a set of training data at the network entity, or both.

Aspect 14: The method of aspect 13, wherein the first layer is an outermost layer of the plurality of hierarchical layers trained at the auto-encoder, an innermost layer of the plurality of hierarchical layers trained at the auto-encoder, or both.

Aspect 15: A method for wireless communication at a network entity, comprising: transmitting, to one or more UE, a first set of neural network weights corresponding to a first subset of a plurality of hierarchical layers of a neural network, wherein the plurality of hierarchical layers of the neural network are aggregated at different network entities and associated with different training frequencies in federated training; training, according to a first frequency, a first layer of the plurality of hierarchical layers based at least in part on the first set of neural network weights and one or more UE updates to the plurality of hierarchical layers of the neural network; and receiving, from the one or more UE, a transmission and process the transmission through the plurality of hierarchical layers of the neural network in accordance with the training.

Aspect 16: The method of aspect 15, further comprising: receiving, from at least one UE of the one or more UE, at least a portion of a set of training data at the at least one UE.

Aspect 17: The apparatus of aspect 16, wherein the portion of the set of training data comprises channel state information feedback.

Aspect 18: The method of any of aspects 15 through 17, further comprising: receiving the transmission from at least one UE of the one or more UE comprising a second set of neural network weights for the first layer; combining the second set of neural network weights for the at least one UE of the one or more UE; and training the first layer based at least in part on the combined second set of neural network weights, wherein the one or more UE updates comprise the combined second set of neural network weights.

Aspect 19: The method of any of aspects 15 through 18, wherein transmitting the first set of neural network weights further comprises: determining the one or more UE are part of a group of UE within a radio unit.

Aspect 20: The method of aspect 19, wherein the radio unit is part of a group of radio units within a distributed unit, and a second layer of the plurality of hierarchical layers is trained by the radio unit based at least in part on a set of training data from the UE, a set of training data at the radio unit, or both.

Aspect 21: The method of aspect 20, wherein the distributed unit is part of a group of distributed units within a centralized unit, and a third layer of the plurality of hierarchical layers is trained by the distributed unit based at least in part on the set of training data at the UE, the set of training data at the radio unit, a set of training data at the distributed unit, or any combination thereof.

Aspect 22: The method of aspect 21, wherein the centralized unit is part of a group of centralized units within a core network, and a fourth layer of the plurality of hierarchical layers is trained by the centralized unit based at least in part on the set of training data at the UE, the set of training data at the radio unit, the set of training data at the distributed unit, a set of training data at the centralized unit, or any combination thereof.

Aspect 23: The method of any of aspects 15 through 22, wherein processing the transmission further comprises: decoding the transmission based at least in part on an auto-encoder, wherein the hierarchical layers are trained at the auto-encoder based at least in part on a set of training data at the UE, a set of training data at the network entity, or both.

Aspect 24: The method of aspect 23, wherein a second layer of the plurality of hierarchical layers is associated with a first UE of the one or more UE and a third layer of the plurality of hierarchical layers is associated with a second UE of the one or more UE, and the first layer, the second layer, and the third layer are trained at the auto-encoder.

Aspect 25: The method of aspect 24, wherein the second layer, the third layer, or both are an outermost layer of the plurality of hierarchical layers trained at the auto-encoder, an innermost layer of the plurality of hierarchical layers trained at the auto-encoder, or both.

Aspect 26: An apparatus for wireless communication at a UE, comprising a processor; memory coupled with the processor; and instructions stored in the memory and executable by the processor to cause the apparatus to perform a method of any of aspects 1 through 14.

Aspect 27: An apparatus for wireless communication at a UE, comprising at least one means for performing a method of any of aspects 1 through 14.

Aspect 28: A non-transitory computer-readable medium storing code for wireless communication at a UE, the code comprising instructions executable by a processor to perform a method of any of aspects 1 through 14.

Aspect 29: An apparatus for wireless communication at a network entity, comprising a processor; memory coupled with the processor; and instructions stored in the memory and executable by the processor to cause the apparatus to perform a method of any of aspects 15 through 25.

Aspect 30: An apparatus for wireless communication at a network entity, comprising at least one means for performing a method of any of aspects 15 through 25.

Aspect 31: A non-transitory computer-readable medium storing code for wireless communication at a network entity, the code comprising instructions executable by a processor to perform a method of any of aspects 15 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive, from a network entity, a first set of neural network weights corresponding to a first subset of a plurality of hierarchical layers of a neural network, wherein the plurality of hierarchical layers of the neural network are aggregated at different network entities and associated with different training frequencies in federated training;
train, according to a first training frequency, a first layer of the plurality of hierarchical layers based at least in part on the first set of neural network weights and a set of training data at the UE, wherein the first layer is outside of the first subset of the plurality of hierarchical layers; and
perform a transmission to the network entity, wherein the transmission is processed at the UE through the plurality of hierarchical layers of the neural network in accordance with the training.

2. The apparatus of claim 1, wherein the instructions are further executable by the processor to cause the apparatus to:
transmit, to the network entity, at least a portion of the set of training data at the UE.

3. The apparatus of claim 2, wherein the portion of the set of training data comprises channel state information feedback.

4. The apparatus of claim 1, wherein the instructions are further executable by the processor to cause the apparatus to:
train a second layer of the plurality of hierarchical layers based at least in part on training the first layer and the set of training data at the UE, wherein the first set of neural network weights corresponds to the second layer; and
transmit, to the network entity, a second set of neural network weights for the second layer based at least in part on training the second layer.

5. The apparatus of claim 1, wherein the instructions are further executable by the processor to cause the apparatus to:
combine the first set of neural network weights corresponding to a second layer of the plurality of hierarchical layers and a second set of neural network weights produced from training the first layer to obtain a combined set of neural network weights;
train the plurality of hierarchical layers of the neural network based at least in part on the combined set of neural network weights and the set of training data at the UE, the training producing a third set of neural network weights; and
perform the transmission to the network entity comprising the third set of neural network weights based at least in part on training the plurality of hierarchical layers.

6. The apparatus of claim 1, wherein the instructions to perform the transmission are executable by the processor to cause the apparatus to:
apply, at a first time, a second layer of the plurality of hierarchical layers to a set of data, wherein the first set of neural network weights corresponds to the second layer; and
apply, at a second time after the first time, the first layer to the set of data to obtain the transmission.

7. The apparatus of claim 1, wherein the instructions to perform the transmission are executable by the processor to cause the apparatus to:
combine the first set of neural network weights corresponding to a second layer of the plurality of hierarchical layers and a second set of neural network weights produced from training the first layer to obtain a combined set of neural network weights;
apply, at a first time, a second layer of the plurality of hierarchical layers to a set of data, wherein the second layer is trained according to the combined set of neural network weights; and
apply, at a second time after the first time, the first layer to the set of data to obtain the transmission.

8. The apparatus of claim 1, wherein the instructions are further executable by the processor to cause the apparatus to:
train, according to a second training frequency, one or more copies of the first layer of the plurality of hierarchical layers based at least in part on the first set of neural network weights and an additional set of training data at the UE.

9. The apparatus of claim 1, wherein the instructions to train the first layer are further executable by the processor to cause the apparatus to:
determine the UE is part of a group of UEs within a radio unit.

10. The apparatus of claim 9, wherein the radio unit is part of a group of radio units within a distributed unit, and a second layer of the plurality of hierarchical layers is trained by the radio unit based at least in part on the set of training data at the UE, a set of training data at the radio unit, or both.

11. The apparatus of claim 10, wherein the distributed unit is part of a group of distributed units within a centralized unit, and a third layer of the plurality of hierarchical layers is trained by the distributed unit based at least in part on the set of training data at the UE, the set of training data at the radio unit, a set of training data at the distributed unit, or any combination thereof.

12. The apparatus of claim 11, wherein the centralized unit is part of a group of centralized units within a core network, and a fourth layer of the plurality of hierarchical layers is trained by the centralized unit based at least in part on the set of training data at the UE, the set of training data at the radio unit, the set of training data at the distributed unit, a set of training data at the centralized unit, or any combination thereof.

13. The apparatus of claim 1, wherein the instructions are further executable by the processor to cause the apparatus to:
process the transmission using an auto-encoder, wherein the hierarchical layers are trained at the auto-encoder based at least in part on the set of training data at the UE, a set of training data at the network entity, or both.

14. The apparatus of claim 13, wherein the first layer is an outermost layer of the plurality of hierarchical layers trained at the auto-encoder, an innermost layer of the plurality of hierarchical layers trained at the auto-encoder, or both.

15. An apparatus for wireless communication at a network entity, comprising:
a processor;
memory coupled with the processor; and
instructions stored in the memory and executable by the processor to cause the apparatus to:
transmit, to one or more user equipment (UE), a first set of neural network weights corresponding to a first subset of a plurality of hierarchical layers of a neural network, wherein the plurality of hierarchical layers of the neural network are aggregated at different network entities and associated with different training frequencies in federated training;
train, according to a first frequency, a first layer of the plurality of hierarchical layers based at least in part on the first set of neural network weights and one or more UE updates to the plurality of hierarchical layers of the neural network; and
receive, from the one or more UE, a transmission and process the transmission through the plurality of hierarchical layers of the neural network in accordance with the training.

16. The apparatus of claim 15, wherein the instructions are further executable by the processor to cause the apparatus to:
receive, from at least one UE of the one or more UE, at least a portion of a set of training data at the at least one UE.

17. The apparatus of claim 16, wherein the portion of the set of training data comprises channel state information feedback.

18. The apparatus of claim 15, wherein the instructions are further executable by the processor to cause the apparatus to:
receive the transmission from at least one UE of the one or more UE comprising a second set of neural network weights for the first layer;
combine the second set of neural network weights for the at least one UE of the one or more UE; and
train the first layer based at least in part on the combined second set of neural network weights, wherein the one or more UE updates comprise the combined second set of neural network weights.

19. The apparatus of claim 15, wherein the instructions to transmit the first set of neural network weights are further executable by the processor to cause the apparatus to:
determine the one or more UE are part of a group of UE within a radio unit.

20. The apparatus of claim 19, wherein the radio unit is part of a group of radio units within a distributed unit, and a second layer of the plurality of hierarchical layers is trained by the radio unit based at least in part on a set of training data from the UE, a set of training data at the radio unit, or both.

21. The apparatus of claim 20, wherein the distributed unit is part of a group of distributed units within a centralized unit, and a third layer of the plurality of hierarchical layers is trained by the distributed unit based at least in part on the set of training data at the UE, the set of training data at the radio unit, a set of training data at the distributed unit, or any combination thereof.

22. The apparatus of claim 21, wherein the centralized unit is part of a group of centralized units within a core network, and a fourth layer of the plurality of hierarchical layers is trained by the centralized unit based at least in part on the set of training data at the UE, the set of training data at the radio unit, the set of training data at the distributed unit, a set of training data at the centralized unit, or any combination thereof.

23. The apparatus of claim 15, wherein the instructions executable by the processor to cause the apparatus to process the transmission are further executable by the processor to cause the apparatus to:
decode the transmission based at least in part on an auto-encoder, wherein the hierarchical layers are trained at the auto-encoder based at least in part on a set of training data at the UE, a set of training data at the network entity, or both.

24. The apparatus of claim 23, wherein a second layer of the plurality of hierarchical layers is associated with a first UE of the one or more UE and a third layer of the plurality of hierarchical layers is associated with a second UE of the one or more UE, and wherein the first layer, the second layer, and the third layer are trained at the auto-encoder.

25. The apparatus of claim 24, wherein the second layer, the third layer, or both are an outermost layer of the plurality of hierarchical layers trained at the auto-encoder, an innermost layer of the plurality of hierarchical layers trained at the auto-encoder, or both.

26. A method for wireless communication at a user equipment (UE), comprising:
receiving, from a network entity, a first set of neural network weights corresponding to a first subset of a plurality of hierarchical layers of a neural network, wherein the plurality of hierarchical layers of the neural network are aggregated at different network entities and associated with different training frequencies in federated training;
training, according to a first training frequency, a first layer of the plurality of hierarchical layers based at least in part on the first set of neural network weights and a set of training data at the UE, wherein the first layer is outside of the first subset of the plurality of hierarchical layers; and
performing a transmission to the network entity, wherein the transmission is processed at the UE through the plurality of hierarchical layers of the neural network in accordance with the training.

27. The method of claim 26 further comprising:
transmitting, to the network entity, at least a portion of the set of training data at the UE.

28. The method of claim 26 further comprising:
training a second layer of the plurality of hierarchical layers based at least in part on training the first layer and the set of training data at the UE, wherein the first set of neural network weights corresponds to the second layer; and
transmitting, to the network entity, a second set of neural network weights for the second layer based at least in part on training the second layer.

29. The method of claim 26 further comprising:
combining the first set of neural network weights corresponding to a second layer of the plurality of hierarchical layers and a second set of neural network weights produced from training the first layer to obtain a combined set of neural network weights;
training the plurality of hierarchical layers of the neural network based at least in part on the combined set of neural network weights and the set of training data at the UE, the training producing a third set of neural network weights; and
performing the transmission to the network entity comprising the third set of neural network weights based at least in part on training the plurality of hierarchical layers.

30. A method for wireless communication at a network entity, comprising:
transmitting, to one or more user equipment (UE), a first set of neural network weights corresponding to a first subset of a plurality of hierarchical layers of a neural network, wherein the plurality of hierarchical layers of the neural network are aggregated at different network entities and associated with different training frequencies in federated training;
training, according to a first frequency, a first layer of the plurality of hierarchical layers based at least in part on the first set of neural network weights and one or more UE updates to the plurality of hierarchical layers of the neural network; and
receiving, from the one or more UE, a transmission and processing the transmission through the plurality of hierarchical layers of the neural network in accordance with the training.
